(19) United States
(12) Patent Application Publication
(10) Pub. No.: US 2015/0278237 A1
(43) Pub. Date: Oct. 1, 2015

(54) SYSTEM AND METHOD FOR FILE SELECTION, INFORMATION PROCESSOR, AND TERMINAL

(71) Applicant: FUJITSU LIMITED, Kawasaki-shi (JP)

(72) Inventors: Naoki Nishiguchi, Kawasaki (JP); Hiroyasu Sugano, Koto (JP); HIROKAZU ARITAKE, Atsugi (JP)

(21) Appl. No.: 14/738,440

(22) Filed: Jun. 12, 2015

Related U.S. Application Data
(63) Continuation of application No. PCT/JP2012/084098, filed on Dec. 28, 2012.

(51) Int. Cl. G06F 17/30

(52) U.S. Cl. CPC G06F 17/30115; G06F 17/30144; G06F 17/30309

(57) ABSTRACT

A file selection system includes a terminal and an information processor. The terminal transmits, to the information processor, files and usage history records each including information on a file use position at which a corresponding one of the files was used. The information processor receives the files and the usage history records transmitted from the terminal, and determines, based on each of the usage history records, a place with a spatial extent including the file use position. The information processor manages each of the files in association with the corresponding place. Then, the information processor selects files according to one or more places to which the terminal is scheduled to move, and transmits the selected files to the terminal.

### CROSS-REFERENCE TO RELATED APPLICATION

This application is a continuation application of International Application PCT/JP2012/084098 filed on Dec. 28, 2012 which designated the U.S., the entire contents of which are incorporated herein by reference.

### FIELD

The embodiments discussed herein are related to a file selection system, an information processor, a terminal, and a file selection method for selecting files.

### BACKGROUND

Multifunctional mobile terminals (for example, smartphones) have many functions including mail, browsers, and camera, and application installation allows yet more new functions to be added to the mobile terminals. Such a multifunctional mobile terminal is able to store a wide range of files according to the usage of the user; however, because the mobile terminal has a limited storage capacity, unwanted stored data needs to be deleted to store new data if storage capacity available to store files is insufficient.

In this case, it is common practice that the user manually selects files to be kept or deleted. However, it is too much trouble to manually select every single file, and therefore techniques for automatic file selection have been proposed. For example, to download files from first information equipment to second information equipment, a proposed technique is to calculate the priority for each file on the basis of operation history information of the second information equipment for the file and download files the priority of which is higher than a predetermined value. Another proposed technique is to provide information of a destination communication area in advance before a mobile terminal enters the communication area.

Japanese Laid-open Patent Publication No. 2000-222296

Japanese Laid-open Patent Publication No. 2004-336598

Mobile terminals are often carried by users and used at places where they are visiting, and users use desired files on the spot. However, conventional file selecting techniques give no consideration to differences in files to be used due to differences in places at which a user uses his or her terminal and, therefore, fail to select appropriate files likely to be used by the user at places he or she is scheduled to visit.

### SUMMARY

According to one embodiment, there is provided a file selection system including a terminal configured to transmit files and usage history records each including information on a file use position at which a corresponding one of the files was used; and an information processor configured to include a processor configured to perform a procedure. The procedure includes receiving the files and the usage history records transmitted from the terminal; determining, based on each of the usage history records, a place with a spatial extent including the file use position; managing each of the files in association with the corresponding place; selecting files according to one or more places to which the terminal is scheduled to move; and transmitting the selected files to the terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a file selection system;

FIG. 2 illustrates a configuration example of a file selection system according to a first embodiment;

FIG. 3 illustrates an overall operation sequence;

FIG. 4 is a flowchart illustrating an operation of a file access monitoring unit;

FIG. 5 illustrates a temporary file information entry;

FIG. 6 illustrates an example of a data structure of a creation history record;

FIG. 7 illustrates an example of a data structure of a usage history record;

FIG. 8 is a flowchart illustrating an operation of a file history transferring unit;

FIG. 9 illustrates an example of a data structure of a file list;

FIG. 10 is a flowchart illustrating an operation of a file receiving unit;

FIG. 11 is a flowchart illustrating an operation of a file history archive unit;

FIG. 12 illustrates an example of data structures of data stored in a creation history storing unit;

FIG. 13 illustrates an example of data structures of data stored in a usage history storing unit;

FIG. 14 illustrates an example of a data structure of place information;

FIG. 15 is a flowchart illustrating an operation of a history converting unit for creation history conversion;

FIG. 16 is a flowchart illustrating an operation of a history converting unit for usage history conversion;

FIG. 17 is a flowchart illustrating an operation of a file determining unit;

FIG. 18 is a flowchart illustrating another operation of the file determining unit;

FIG. 19 is a flowchart illustrating an operation of a file transmitting unit;

FIG. 20 illustrates a configuration example of a file selection system according to a second embodiment;

FIG. 21 illustrates conversion from each position to a place;

FIG. 22 illustrates an example of a data structure of place information;

FIG. 23 illustrates a step in a process of creating the place information;

FIG. 24 illustrates another step in the process of creating the place information;

FIG. 25 illustrates yet another step in the process of creating the place information;

FIG. 26 illustrates yet another step in the process of creating the place information;

FIG. 27 illustrates yet another step in the process of creating the place information;

FIG. 28 illustrates yet another step in the process of creating the place information;

FIG. 29 illustrates yet another step in the process of creating the place information;

FIG. 30 illustrates an example of a data structure of a day history;

FIG. 31 is a flowchart illustrating an operation of a history converting unit for day history conversion;

FIG. 32 is the flowchart illustrating the operation of the history converting unit for the day history conversion, continuing from FIG. 31;

FIG. 33 illustrates a free space calculation process;

FIG. 34 illustrates an example of a data structure of temporary needed size information;

FIG. 35 is a flowchart illustrating an operation of the file determining unit according to the second embodiment;

FIG. 36 is a flowchart illustrating another operation of the file determining unit according to the second embodiment;

FIG. 37 illustrates a configuration example of a file selection system according to a third embodiment;

FIG. 38 is a flowchart illustrating an operation of the file determining unit according to the third embodiment;

FIG. 39 illustrates a configuration example of a file selection system according to a fourth embodiment;

FIG. 40 illustrates an example of data structures of data stored in a place association information storing unit;

FIG. 41 illustrates an operation for setting place identifiers of place association information;

FIG. 42 is a flowchart illustrating an operation of the history converting unit for a day conversion process;

FIG. 43 is a flowchart illustrating an operation of the file history archive unit according to a modification;

FIG. 44 illustrates an example of a data structure of the creation history according to the modification;

FIG. 45 illustrates an example of a data structure of the usage history according to the modification;

FIG. 46 illustrates an example of a data structure of the day history according to the modification;

FIG. 47 is a flowchart illustrating an operation of the history converting unit for day history conversion according to the modification;

FIG. 48 is the flowchart illustrating the operation of the history converting unit for the day history conversion according to the modification, continuing from FIG. 47;

FIG. 49 is a flowchart illustrating an operation of the file determining unit according to the modification;

FIG. 50 is a flowchart illustrating yet another operation of the file determining unit according to the modification;

FIG. 51 illustrates a pattern of activity of a user;

FIG. 52 illustrates history information and history conversion; and

FIG. 53 illustrates an example of a hardware configuration of a computer used for information processors according to the embodiments above.

### DESCRIPTION OF EMBODIMENTS

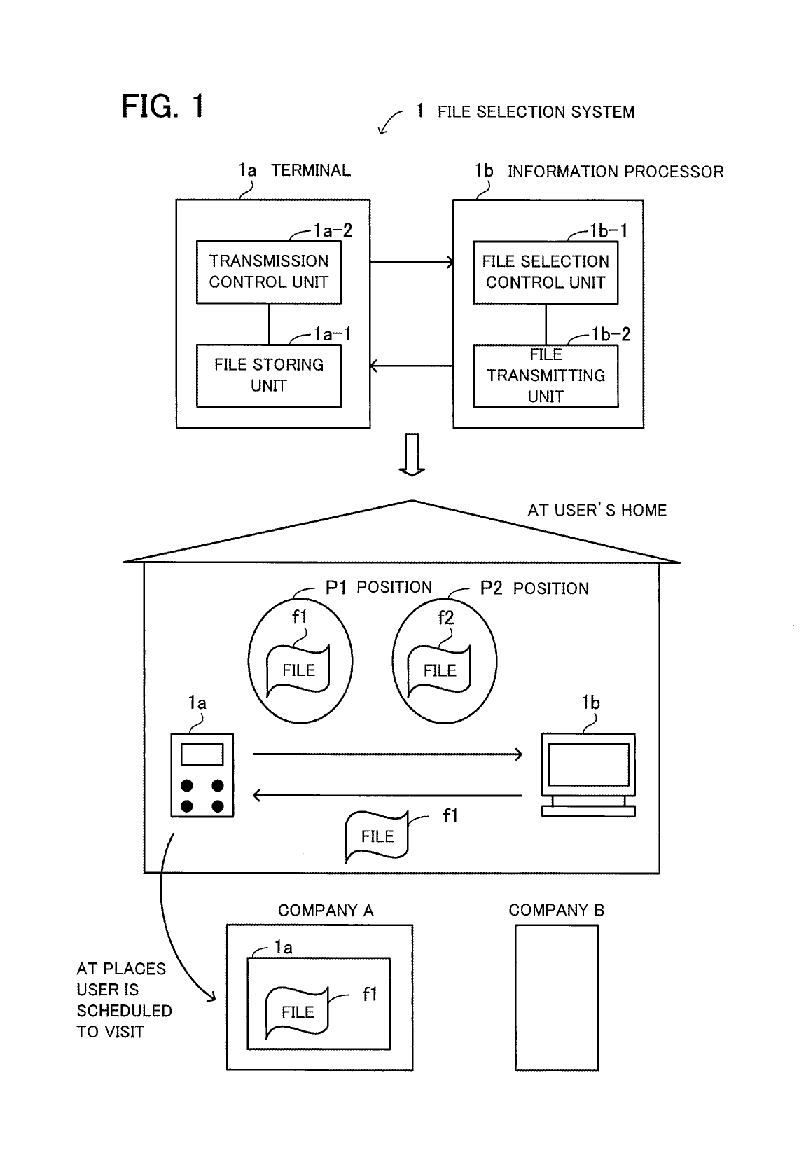

Several embodiments will be described below with reference to the accompanying drawings, wherein like reference numerals refer to like elements throughout. FIG. 1 illustrates a configuration example of a file selection system. A file selection system 1 includes a terminal 1a and an information processor 1b. The terminal 1a is, for example, a mobile terminal device carried by a user. The terminal 1a includes a file storing unit 1a-1 and a transmission control unit 1a-2. The file storing unit 1a-1 stores therein files. The transmission control unit 1a-2 transfers, to the information processor 1b, files and usage history records each including file use positional information. The file use positional information indicates, for example, a position (e.g. latitude and longitude coordinates) of the terminal 1a at which a corresponding file was used. Note that the terminal 1a may be configured to determine a place with a spatial extent including the position at which the file was used. In this case, the place including the position at which the file was used is used as the file use positional information.

The information processor 1b includes a file selection control unit 1b-1 and a file transmitting unit 1b-2. The file selection control unit 1b-1 receives the files and the usage history records transmitted from the terminal 1a. Then, the file selection control unit 1b-1 determines a place with a spatial extent (for example, a geographical name or name of a building) including a position at which a corresponding file was used based on the file use positional information included in each of the received usage history records. For example, in the case of receiving, as the file use positional information, latitude and longitude coordinates of the position at which the file was used, the file selection control unit 1b-1 converts the position indicated by the latitude and longitude coordinates to a place, such as a geographical name. Note that if a place like a geographical name is given as the file use positional information, the file selection control unit 1b-1 determines the place as the place with a spatial extent including the position at which the file was used.

Further, based on each pair of received file and usage history record, the file selection control unit 1b-1 manages a place with a spatial extent including the position at which the file was used in association with the file. The file selection control unit 1b-1 exercises the management each time it receives a pair of a file and a usage history record. As a result, each place is managed by the file selection control unit 1b-1 in association with files used at the place in the past. The file selection control unit 1b-1 selects files according to places to which the terminal 1a is scheduled to move. The file transmitting unit 1b-2 transmits the selected files to the terminal 1a.

Assume here that a user goes out carrying the terminal 1a, and uses a file f1 at a visiting position P1 and uses a file f2 at a visiting position P2. Later, when the user returns home, the terminal 1a connects with the information processor 1b installed at home to establish communication. In this regard, the files and their file usage history records are transferred from the terminal 1a to the information processor 1b. The information processor 1b converts the positions P1 and P2 to places (Company A and Company B, respectively) and manages the places in association with the files used at each of the places. When the user is scheduled to visit the place (Company A) tomorrow, the information processor 1b selects the file f1 used at the place (Company A) based on the schedule of the user and transmits the selected file f1 to the terminal 1a so that a copy of the file f1 is stored in the terminal 1a in advance.

Thus, according to the file selection system 1, a position at which a file was used on the terminal 1a is converted to a place with a spatial extent including the position, and each place is managed in association with corresponding one or more files. Then, according to places to which the terminal 1a is scheduled to move, appropriate files are selected and then transmitted to the terminal 1a. This allows accurate selection of files likely to be used by the user at the places he or she is scheduled to visit, thus enhancing convenience.

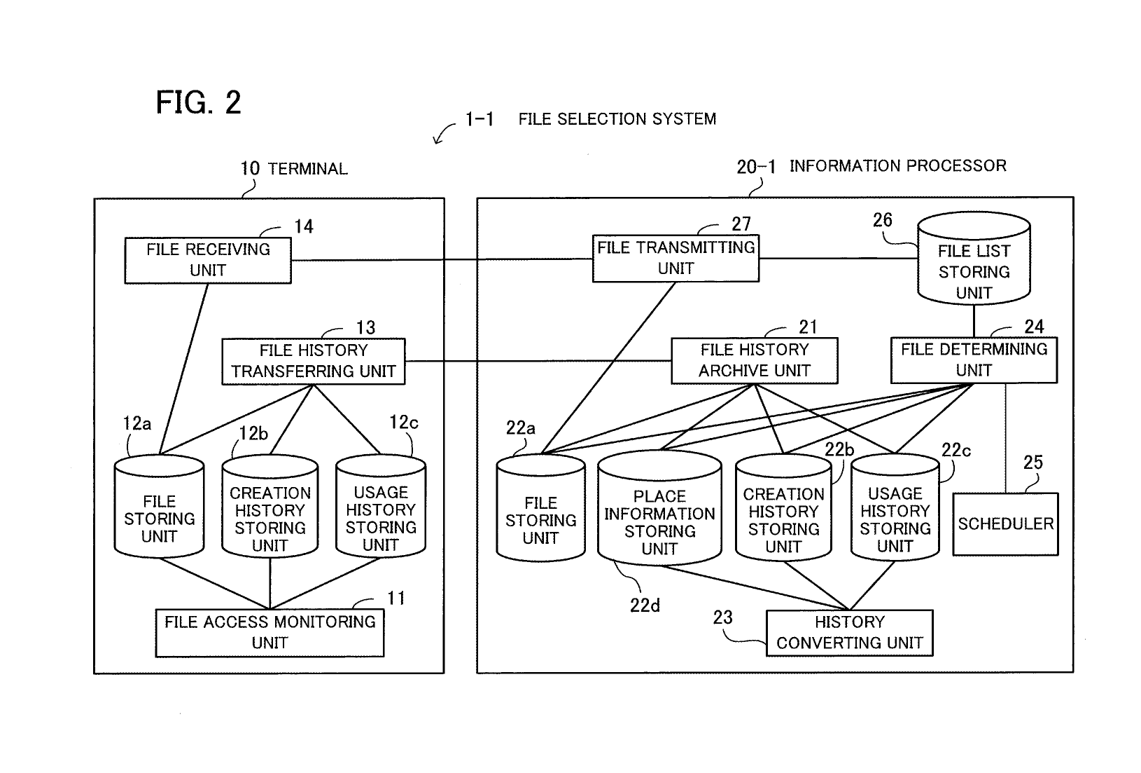

Next described is the configuration of a file selection system according to a first embodiment. FIG. 2 illustrates a configuration example of the file selection system according to the first embodiment. A file selection system 1-1 includes a terminal 10 and an information processor 20-1. The terminal 10 is, for example, a mobile terminal such as a smartphone, and the information processor 20-1 is, for example, a personal computer installed at home of the user.

The terminal 10 is mobile so that the user is able to carry and use it outside. In addition, the terminal 10 and the information processor 20-1 communicate with each other at home to thereby maintain coordination with each other. For example, the terminal 10 and the information processor 20-1 communicate with each other via, for example, a wireless router installed at home.

Alternatively, the terminal 10 and the information processor 20-1 may communicate with each other when the terminal 10 is placed on its cradle at home.

The terminal 10 includes a file access monitoring unit 11, a file storing unit 12a, a creation history storing unit 12b, a usage history storing unit 12c, a file history transferring unit 13, and a file receiving unit 14. Note that the file storing unit 1a-1 of FIG. 1 corresponds to the file storing unit 12a. The functions of the transmission control unit 1a-2 of FIG. 1 are implemented by the file access monitoring unit 11, the creation history storing unit 12b, the usage history storing unit 12c, the file history transferring unit 13, and the file receiving unit 14.

When the user creates a file, for example, the file access monitoring unit 11 accesses the file storing unit 12a, the creation history storing unit 12b, and the usage history storing unit 12c to cause them to store the created file, a creation history record of the file, and a usage history record of the file, respectively. The file storing unit 12a stores files. The creation history storing unit 12b stores creation history records of files. The usage history storing unit 12c stores usage history records of files.

The file history transferring unit 13 reads the files, the creation history records, and the usage history records from the file storing unit 12a, the creation history storing unit 12b, and the usage history storing unit 12c, respectively, and then transfers the read information to the information processor 20-1. The file receiving unit 14 requests the information processor 20-1 to transmit files needed to be copied to its own terminal 10. Then, the file receiving unit 14 receives files transmitted from the information processor 20-1 and causes the file storing unit 12a to store them therein.

On the other hand, the information processor 20-1 includes a file history archive unit 21, a file storing unit 22a, a creation history storing unit 22b, a usage history storing unit 22c, a place information storing unit 22d, a history converting unit 23, a file determining unit 24, a scheduler 25, a file list storing unit 26, and a file transmitting unit 27. Note that the file transmitting unit 1b-2 of FIG. 1 corresponds to the file transmitting unit 27. The functions of the file selection control unit 1b-1 of FIG. 1 are implemented by the file history archive unit 21, the file storing unit 22a, the creation history storing unit 22b, the usage history storing unit 22c, the place information storing unit 22d, the history converting unit 23, the file determining unit 24, the scheduler 25, and the file list storing unit 26.

The file history archive unit 21 receives files, creation history records, and usage history records transferred from the terminal 10, which are then stored in the file storing unit 22a, the creation history storing unit 22b, and the usage history storing unit 22c, respectively. In addition, the file history archive unit converts, into a place, positional information (latitude and longitude coordinates) included in each creation history record or usage history record transferred from the terminal 10, and stores it in the place information storing unit 22d as a place information entry.

The file storing unit 22a stores files. In this regard, the file storing unit 22a stores the following attributes for each file: the date and time when the file was created; the size, and the file path (information including a storage location and a name of the file). The creation history storing unit 22b stores creation history records of files. The usage history storing unit 22c stores usage history records of files. The place information storing unit 22d stores place information entries.

The history converting unit 23 converts stored creation history records, usage history records, and place information entries into information to be used to select files. The file determining unit 24 determines files likely to be taken out from the information processor 20-1 based on the information converted by the history converting unit 23. In addition, the file determining unit 24 creates a list of files (file list) likely to be taken out. The file list storing unit 26 stores the file list. The scheduler 25 stores and manages the schedule of the user.

The file transmitting unit 27 transmits the file list and the determined files to the terminal 10. In this regard, if the files determined by the file determining unit 24 have remained in the terminal 10, it is no need to retransmit the files to the terminal 10. Therefore, the file transmitting unit 27 once transmits the file list indicating files likely to be used to the terminal 10, and by referring to the file list, the file receiving unit 14 then makes a request for files that the terminal 10 does not have and likely to be used. In response, the file transmitting unit 27 transmits the requested files to the terminal 10. Note that the detailed operation of each functional component of the terminal 10 and the information processor 20-1 is described later using flowcharts.

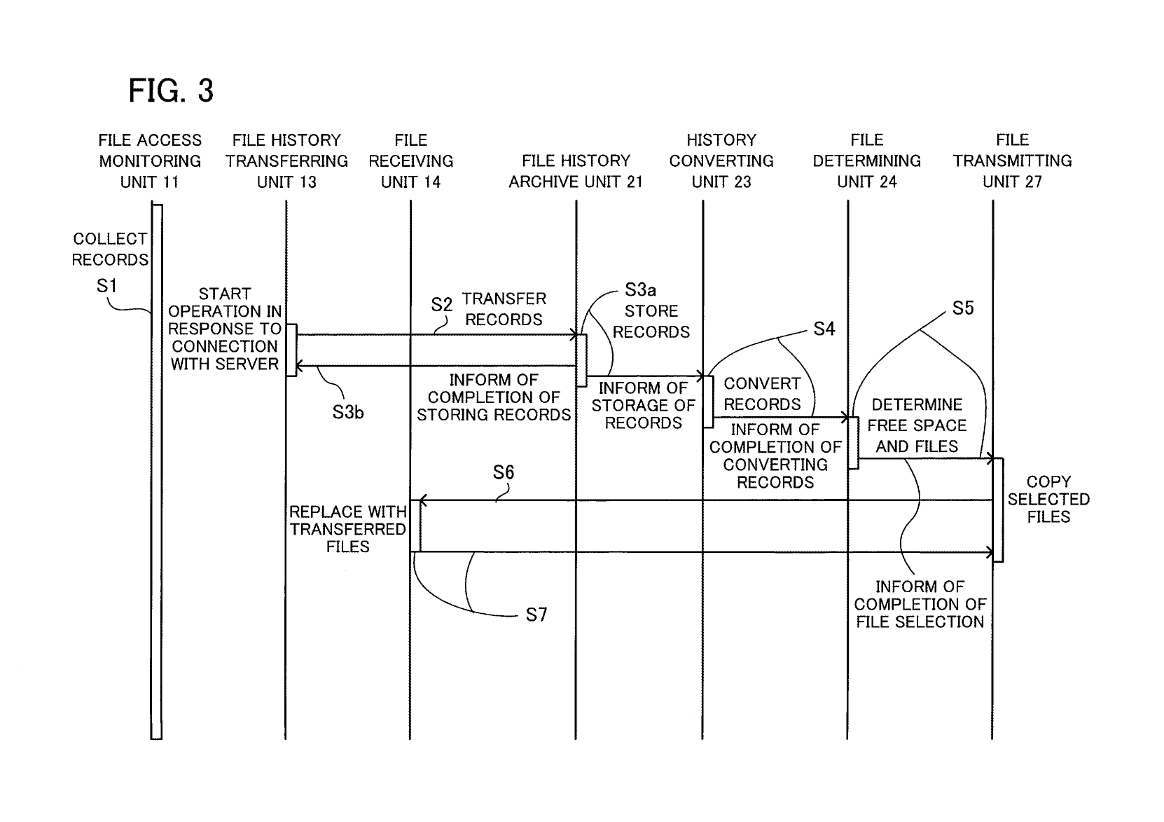

Next described is an overall operation sequence of the file selection system 1-1. FIG. 3 illustrates the overall operation sequence.

[Step S1] The file access monitoring unit 11 monitors file access, for example, by always operating when the terminal 10 is turned on. When access is made to files, the file access monitoring unit 11 collects the use history of the files separately for creation history records and usage history records. Then, the file access monitoring unit 11 saves the files, the creation history records, and the usage history records in the file storing unit 12a, the creation history storing unit 12b, and the usage history storing unit 12c, respectively.

[Step S2] The file history transferring unit 13 starts its operation, for example, in response to establishment of the connection between the terminal 10 and the information processor 20-1. The file history transferring unit 13 transfers the stored files, creation history records, and usage history records to the file history archive unit 21 of the information processor 20-1.

[Step S3a] The file history archive unit 21 receives the transferred files and stores them in the file storing unit 22a. In addition, the file history archive unit 21 receives the transferred creation history records and usage history records and converts positional information included in each of the creation history records and usage history records to a place information entry, and stores the creation history records, the usage history records, and the place information entries in the creation history storing unit 22b, the usage history storing unit 22c, and the place information storing unit 22d, respectively. Subsequently, once completing storing the files and the history information, the file history archive unit 21 informs the history converting unit 23 of the storage.

Note that, in the description above, the information processor 20-1 converts positional information to place information. However, the terminal 10 may use, not latitude and longitude coordinates, but a place as the positional information. In this case, there is no need for the information processor 20-1 to perform the conversion.

[Step S3b] Once completing storing the files and the history information, the file history archive unit 21 informs the file history transferring unit 13 of the completion of the storage.

[Step S4] The history converting unit 23 converts the creation history records, the usage history records, and the place information entries to information used to obtain the amount of free space of the terminal 10 and files likely to be used by the terminal 10. Subsequently, the history converting unit 23 informs the file determining unit 24 of the completion of the conversion.

[Step S5] Based on the information generated by the history converting unit 23, the file determining unit determines the free space needed to create files at places where the user is scheduled to visit and also files likely to be used at the places. Subsequently, the file determining unit 24 informs the file transmitting unit 27 of the completion of the determination.

[Step S6] The file transmitting unit 27 transmits the selected and determined files to the file receiving unit 14 (note that the operation of transmitting a file list and the operation of the terminal 10 making a file request based on the file list are omitted here from the operation sequence).

[Step S7] The file receiving unit 14 stores the files transmitted from the information processor 20-1 in the file storing unit 12a, and then informs the file transmitting unit 27 of the completion of the storage.

Note that during steps S1 and S7, file access in the terminal 10 may be prohibited. This prevents inconsistencies in the files and history records.

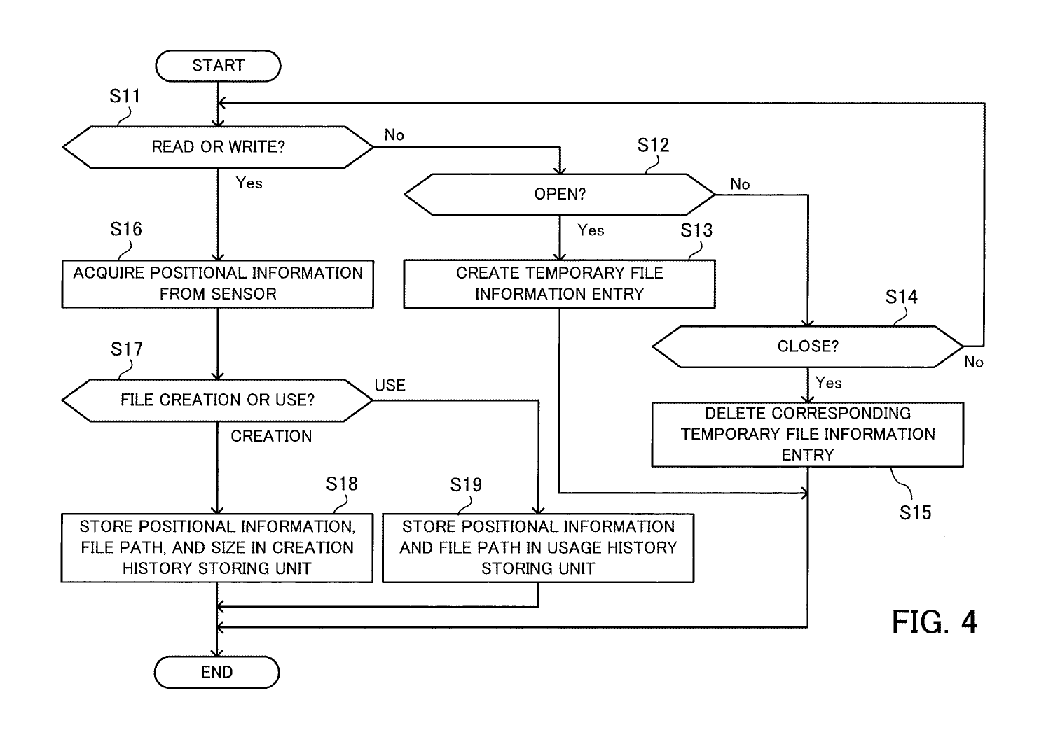

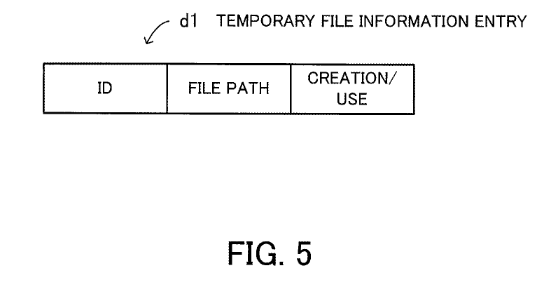

Next described are the functional components of the terminal 10. The operation of the file access monitoring unit 11 is described first. The file access monitoring unit 11 operates, for example, in response to file access. There are four types of file access: Open for opening a file; Close for closing a file; Read for reading a file; and Write for writing a file. In addition, whether creating or using a file is determined by a parameter in the Open statement. FIG. 4 is a flowchart illustrating an operation of the file access monitoring unit.

[Step S11] The file access monitoring unit 11 first determines the type of the file access. If the file access is Read or Write, the operation proceeds to step S16. On the other hand, if the file access is neither Read nor Write, the operation proceeds to step S12.

[Step S12] The file access monitoring unit 11 determines whether the file access is Open. If the file access is Open, the operation proceeds to step S13. If not, the operation proceeds to step S14.

[Step S13] When the file access is Open, the file access monitoring unit 11 creates a temporary file information entry. The temporary file information entry includes the identifier (ID) indicating a corresponding file, the file path, and a flag indicating creating or using the file (as will be described in FIG. 5).

[Step S14] The file access monitoring unit 11 determines whether the file access is Close. If the file access is Close, the operation proceeds to step S15. If not, the operation returns to step S11.

[Step S15] When the file access is Close, the file access monitoring unit 11 deletes a corresponding temporary file information entry.

[Step S16] When the file access is either one of Read and Write, the file access monitoring unit 11 acquires positional information from a sensor provided in the terminal 10. The positional information indicates latitude and longitude coordinates. The sensor is, for example, a global positioning system (GPS), an acceleration sensor, or an orientation sensor. Alternatively, the positional information may be obtained, for example, using a positioning service by a wireless local area network (WLAN).

[Step S17] Based on a corresponding temporary file information entry, the file access monitoring unit 11 determines whether the file access is to create or use a file. If the file access is to create the file, the operation proceeds to step S18. If the file access is to use the file, the operation proceeds to step S19.

[Step S18] The file access monitoring unit 11 stores the positional information, file path, and size of the created file in the creation history storing unit 12b.

[Step S19] The file access monitoring unit 11 stores the positional information and file path of the used file in the usage history storing unit 12c.

Note that frequent Read/Write operations result in a large number of history records being stored. In such a case, it may be configured not to store history records for access made during a predetermined time frame and access made within a predetermined area.

FIG. 5 illustrates a temporary file information entry. As described above, a temporary file information entry d1 is generated by the file access monitoring unit 11 and includes the identifier indicating a corresponding file, the file path, and a flag indicating file creation or usage. The identifier includes, for example, a pair of a process identifier of a process having opened the file and a file descriptor of the opened file. The file descriptor is a return value from Open, and is the identifier of the file, used for Read, Write, and Close. Because the file descriptor is assigned to each process, a unique identifier is created by paring up the file descriptor with the process identifier. The file path is a full-path file name (an input method used to specify a file name, which fully specifies names of all directories on the path from a drive with no omission). Whether creating or using a file is determined by a parameter in the Open statement. For example, in the case of UNIX (registered trademark), a flag O_CREAT is set to create a new file when the file is opened. When this flag is set, it is determined to create the file, and when this flag is not set, it is determined to use the file.

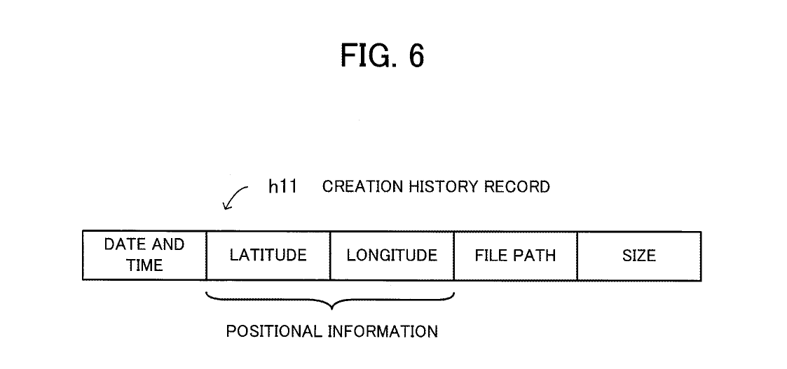

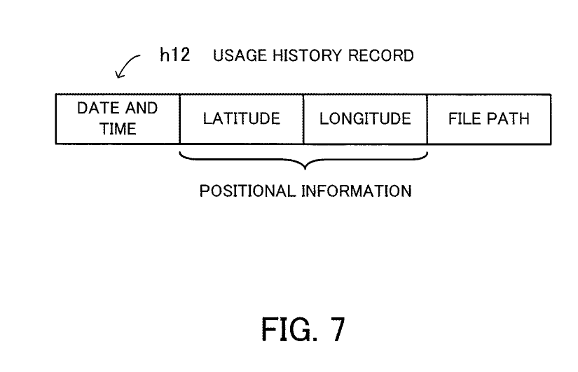

Next described are data structures of a creation history record and a usage history record stored in the creation history storing unit 12b and the usage history storing unit 12c, respectively, of the terminal 10. FIG. 6 illustrates an example of the data structure of a creation history record, and FIG. 7 illustrates an example of the data structure of a usage history record. A creation history record h11 includes the following attributes: date and time; latitude; longitude; file path; and size. A usage history record h12 includes the following attributes: date and time, latitude, longitude, and file path. The date and time indicate when corresponding file access was made. The latitude and longitude represent positional information associated with the file access, acquired from a GPS or the like. The file path represents the name of the file. The size represents the size of the file. Note that the file storing unit 12a is, for example, a file system employed on a memory card, and files are stored in the file system.

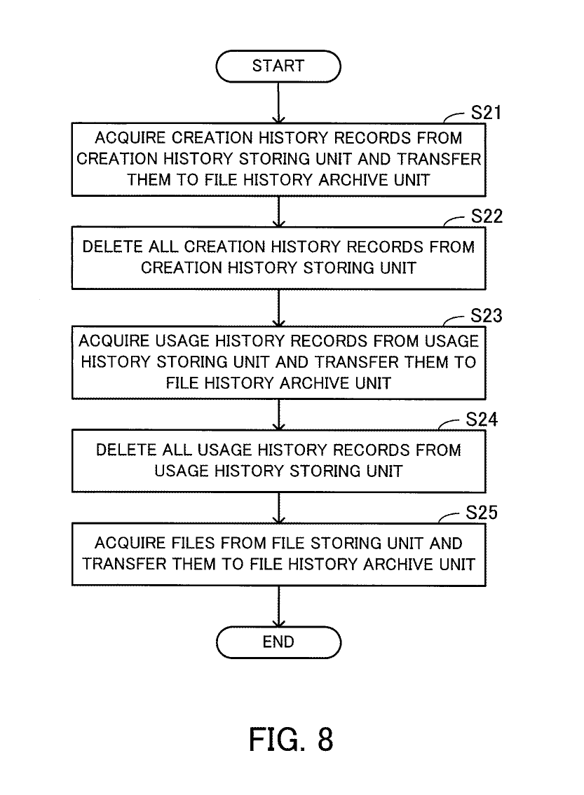

Next described is the operation of the file history transferring unit 13. FIG. 8 is a flowchart illustrating an operation of the file history transferring unit. The file history transferring unit 13 starts the operation, for example, in response to the terminal 10 being connected to the information processor 20-1.

[Step S21] The file history transferring unit 13 acquires creation history records from the creation history storing unit 12b and transfers them to the file history archive unit 21.

[Step S22] After transferring the creation history records, the file history transferring unit 13 deletes all the creation history records from the creation history storing unit 12b.

[Step S23] The file history transferring unit 13 acquires usage history records from the usage history storing unit 12c and transfers them to the file history archive unit 21.

[Step S24] After transferring the usage history records, the file history transferring unit 13 deletes all the usage history records from the usage history storing unit 12c.

[Step S25] The file history transferring unit 13 acquires files from the file storing unit 12a and transfers them to the file history archive unit 21.

Because the terminal 10 does not use the creation and usage history records, these history records are deleted after being transferred to the information processor 20-1 in the description above. Note however that file access may be made during the history record transfer. In view of this, creation and usage history records having yet to be transferred to the information processor 20-1 are not deleted.

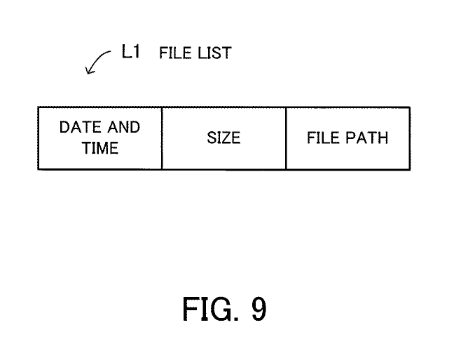

Next described is the operation of the file receiving unit 14. Prior to receiving files eventually selected by the information processor 20-1, the file receiving unit 14 first receives a file list including files likely to be used by the user at places he or she is scheduled to visit. FIG. 9 illustrates an example of the data structure of the file list. A file list L1 is created by the information processor 20-1 and includes attributes of files likely to be used by the user at places he or she is scheduled to visit. As the attributes, date and time, size, and file path are registered.

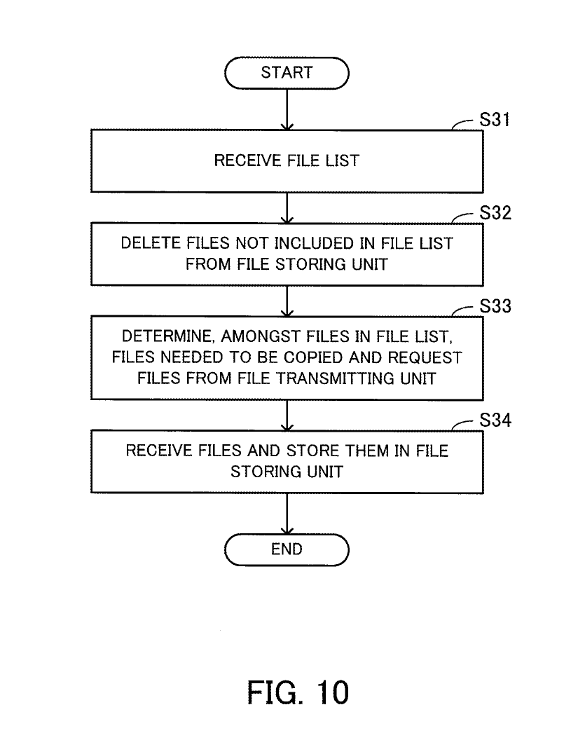

FIG. 10 is a flowchart illustrating an operation of the file receiving unit.

[Step S31] The file receiving unit 14 receives a file list transmitted from the file transmitting unit 27 of the information processor 20-1.

[Step S32] The file receiving unit 14 recognizes files having the same file paths as those included in the received file list as files to be kept in the file storing unit 12a. Then, the file receiving unit 14 deletes files having file paths not included in the file list from the file storing unit 12a.

In this regard, as for each of the files having the same file paths as those included in the file list, the date and time of the file in the file storing unit 12a may be older than the date and time on the file list. In such a case, the file receiving unit 14 deletes the file with the older date and time from the file storing unit 12a.

[Step S33] The file receiving unit 14 deletes the files kept in the file storing unit 12a from the file list, and then sends the file list (i.e. the file list indicating files to be copied to the terminal 10) back to the file transmitting unit 27 after the deletion.

[Step S34] Based on the returned file list, the information processor 20-1 selects files to be transmitted to the terminal 10, and transmits the selected files by the file transmitting unit 27. The file receiving unit 14 receives the files transmitted from the information processor 20-1 and stores them in the file storing unit 12a.

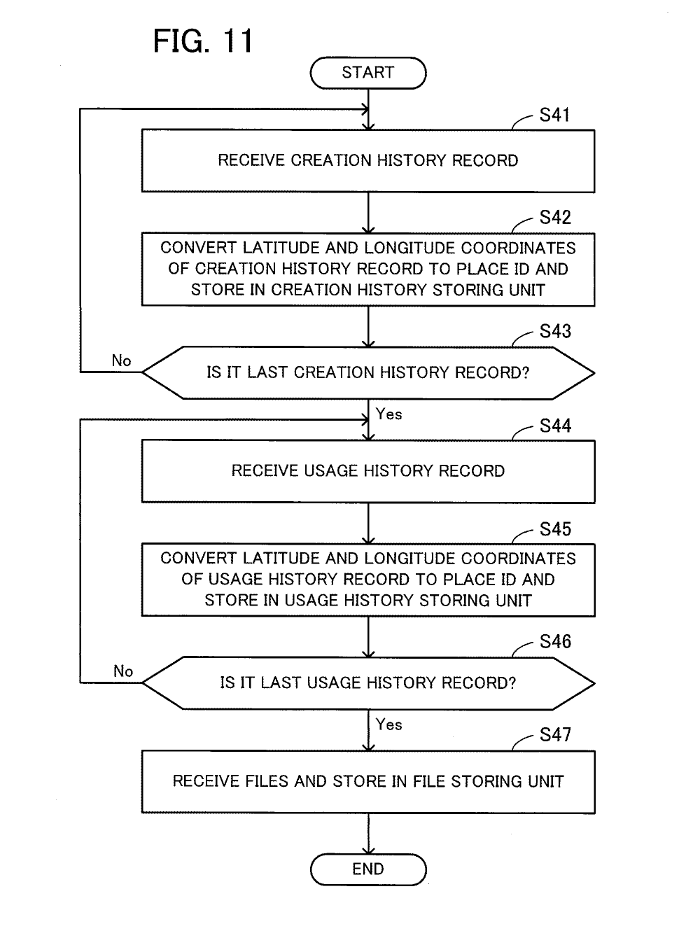

Next described are the functional components of the information processor 20-1. The operation of the file history archive unit 21 is described first. FIG. 11 is a flowchart illustrating an operation of the file history archive unit. The file history archive unit 21 starts the operation, for example, in response to establishment of the connection with the file history transferring unit 13. Subsequently, the file history archive unit 21 receives creation history records, usage history records, and files, and then carries out storing processes.

[Step S41] The file history archive unit 21 receives creation history records. The example provided here is that the file history archive unit 21 receives one creation history record at a time; however, the file history archive unit 21 may receive the creation history records at one time and then store the creation history records in the creation history storing unit 22b one at a time.

[Step S42] The file history archive unit 21 converts the latitude and longitude coordinates included in the creation history record to a place identifier, and stores the converted creation history record in the creation history storing unit 22b.

[Step S43] The file history archive unit 21 determines whether the creation history record currently targeted is the last creation history record being the subject of the storing. If the creation history record is not the last one, the operation returns to step S41. On the other hand, if the creation history record is the last one, the operation proceeds to step S44.

[Step S44] The file history archive unit 21 receives usage history records. The example provided here is that the file history archive unit 21 receives one usage history record at a time; however, the file history archive unit 21 may receive the usage history records at one time and then store the usage history records in the usage history storing unit 22c one at a time.

[Step S45] The file history archive unit 21 converts the latitude and longitude coordinates included in the usage history record to a place identifier, and stores the converted usage history record in the usage history storing unit 22c.

[Step S46] The file history archive unit 21 determines whether the usage history record currently targeted is the last usage history record being the subject of the storing. If the usage history record is not the last one, the operation returns to step S44. On the other hand, if the usage history record is the last one, the operation proceeds to step S47.

[Step S47] The file history archive unit 21 receives files and stores the received files in the file storing unit 22a.

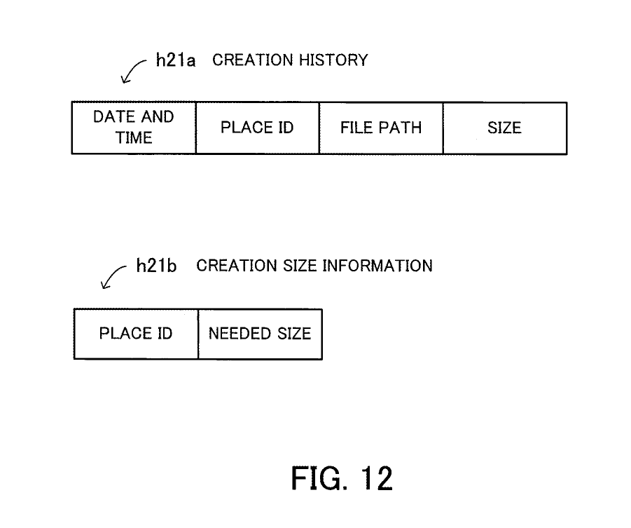

Next described are the data structures of data stored in the creation history storing unit 22b and the usage history storing unit 22c of the information processor 20-1. FIG. 12 illustrates an example of the data structures of data stored in the creation history storing unit. The creation history storing unit 22b stores therein a creation history h21a and creation size information h21b. Each record in the creation history h21a includes the following attributes: date and time, place identifier (ID), file path, and size. Each entry in the creation size information h21b includes attributes of place identifier and needed size. Each entry in the creation size information h21b indicates the total file size of files having been created at a place identified by the place identifier. Note that the creation size information h21b is data created by the history converting unit 23 converting the creation history h21a.

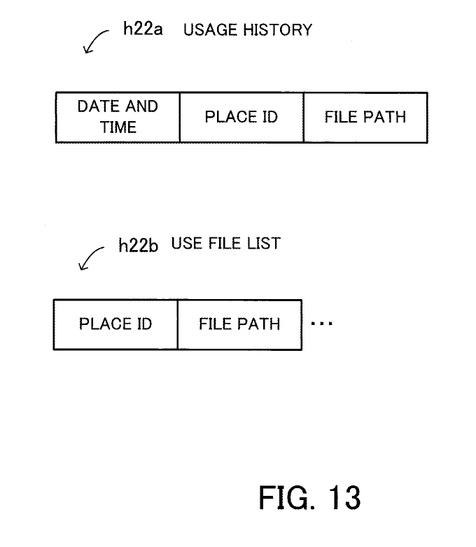

FIG. 13 illustrates an example of the data structures of data stored in the usage history storing unit. The usage history storing unit 22c stores therein a usage history h22a and a use file list h22b. Each record in the usage history h22a includes attributes of date and time, place identifier, and file path. Each entry included in the use file list h22b includes attributes of place identifier and file path. The use file list h22b is a list of attributes of files having been used at a place identified by each place identifier. Note that the use file list h22b is data created by the history converting unit 23 converting the usage history h22a.

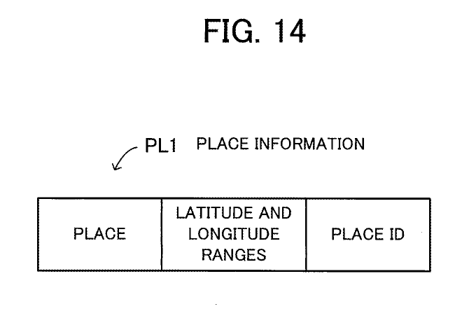

Next described is the data structure of data stored in the place information storing unit 22d. FIG. 14 illustrates an example of the data structure of the place information. Each entry in place information PL1 is composed of a place (e.g. a geographical name or name of a building), latitude and longitude ranges, and a place identifier. Assume here that places have been registered in the scheduler 25 in advance. The file history archive unit 21 acquires, for example, the user's schedule for tomorrow from the scheduler 25, and searches the place information PL1 for an entry associated with each place recognized in the schedule.

If an entry including the place is not found in the place information PL1 of the place information storing unit 22d, the file history archive unit 21 converts the place recognized in the schedule to latitude and longitude coordinates and assigns a place identifier to thereby create a new entry, which is then additionally stored in the place information PL1 of the place information storing unit 22d. In this regard, the conversion of the place to latitude and longitude coordinates is implemented using, for example, an application programming interface (API) released as a Web service. In addition, the assignment of a place identifier to the latitude and longitude coordinates is implemented by searching the place information PL1 for an entry whose latitude and longitude ranges contain the latitude and longitude coordinates and converting the coordinates to a place identifier included in the found entry. If no entry is found in the place information PL1, the latitude and longitude coordinates are converted to a place, for example, using a Web service. Then, an entry including the converted place is found in the place information PL1, the latitude and longitude coordinates are converted to a place identifier included in the entry. If no entry including the converted place is found in the place information PL1, a new place identifier is assigned to the latitude and longitude coordinates.

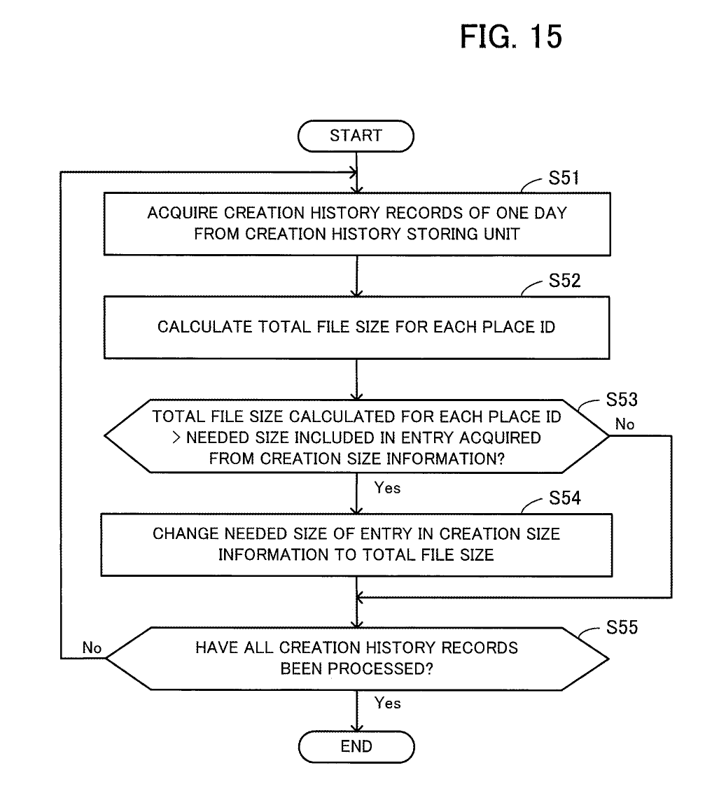

Next described is the operation of the history converting unit 23. The history converting unit 23 performs creation history conversion and usage history conversion. FIG. 15 is a flowchart illustrating an operation of the history converting unit for the creation history conversion. Note that FIG. 15 illustrates the case where the conversion is carried out for creation history records by the day.

[Step S51] The history converting unit 23 designates a date to acquire, amongst creation history records stored in the creation history storing unit 22b, creation history records of the day.

[Step S52] The history converting unit 23 calculates the total file size for each place identifier of the creation history records.

[Step S53] The history converting unit 23 acquires, from existing creation size information stored in the creation history storing unit 22b, an entry having the place identifier for which the total file size is calculated in step S52.

Then, the history converting unit 23 compares the value of the needed size included in the acquired entry having the place identifier and the value of the total file size calculated in step S52. If the value of the total file size is larger than the value of the needed size included in the acquired entry, the operation proceeds to step S54. On the other hand, if the value of the total file size is not larger than the value of the needed size of the acquired entry, the operation proceeds to step S55. This comparison is made for each place identifier, and the determination of step S54 or S55 is also made for each place identifier.

[Step S54] The history converting unit 23 changes the value of the needed size of the entry having the place identifier to the value of the total file size, and then stores the changed entry in the creation size information of the creation history storing unit 22b.

[Step S55] The history converting unit 23 determines whether all creation history records have been processed. If all the creation history records have been processed, the operation ends. On the other hand, if one or more creation history records remain to be processed, the operation returns to step S51.

Note that the above illustrates an example of setting the maximum size of files created in one day for each place as the needed size of the place. Instead, the average size of files created in one day for each place may be set as the needed size of the place. In addition, instead of converting all the creation history records, the conversion may be performed only on creation history records newly added to the information processor 20-1 by the terminal 10.

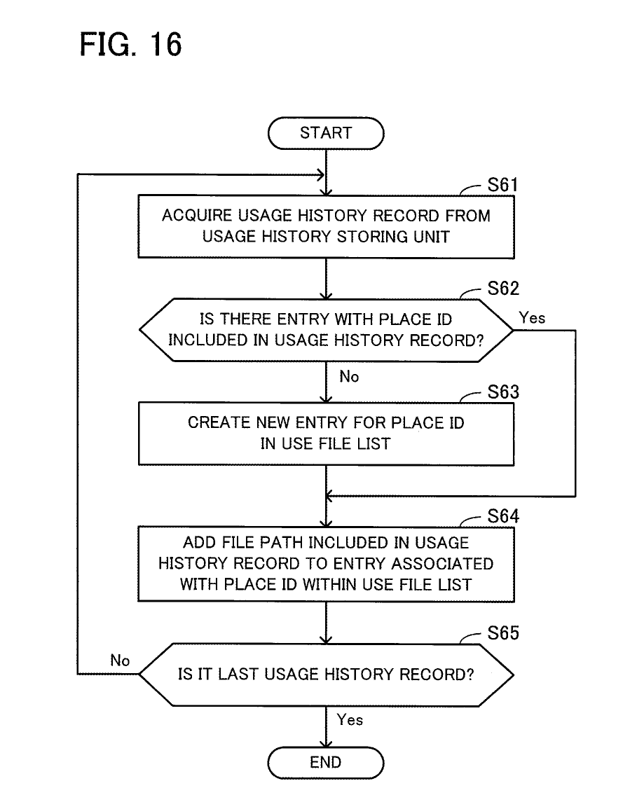

FIG. 16 is a flowchart illustrating an operation of the history converting unit for the usage history conversion.

[Step S61] The history converting unit 23 acquires a usage history record from the usage history storing unit 22c (assume in the usage history conversion that the conversion is performed by acquiring one usage history record at a time).

[Step S62] The history converting unit 23 determines whether, within existing use file list stored in the usage history storing unit 22c, there is an entry with a place identifier included in the usage history record. If there is no such an entry in the use file list stored in the usage history storing unit 22c, the operation proceeds to step S63. On the other hand, if the entry is found, the operation proceeds to step S64.

[Step S63] The history converting unit 23 creates, in the use file list, a new entry for the place identifier of the usage history record.

[Step S64] The history converting unit 23 adds a file path included in the usage history record to the entry associated with the place identifier within the use file list.

Assume, for example, that an existing use file list has an entry with attributes of a place identifier of #1 and a file path of aa while the usage history record has attributes of a place identifier of #1 and a file path of bb. In this case, the history converting unit 23 adds the file path bb to the file path included in the entry associated with the place identifier #1. As a result, an entry with the place identifier #1 and the file paths aa and bb is created in the use file list.

[Step S65] The history converting unit 23 determines whether the usage history record currently targeted is the last usage history record being the subject of the conversion. If the usage history record is the last one, the operation ends. If not, the operation returns to step S61.

Note that if a file was used only on the same day as the file being created, the file need not be taken out from the information processor 20-1. Therefore, files each having the date of usage being the same as its creation date may not be included in the use file list. In this regard, the history converting unit 23 acquires, from the creation history storing unit 22b, a creation history record with a file path being the same as that included in each usage history record, and checks whether the date in the usage history record is the same as that in the creation history record.

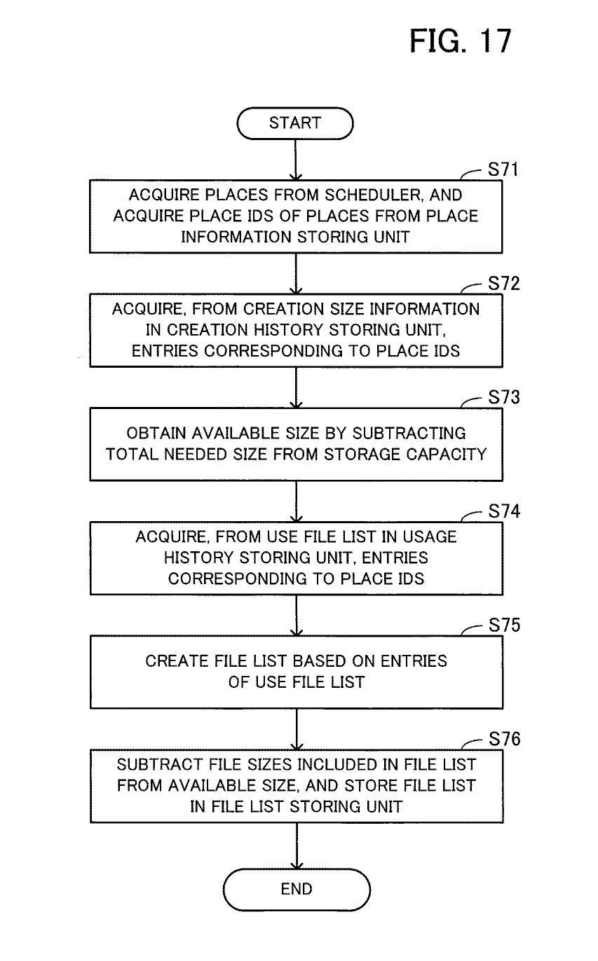

Next described is the operation of the file determining unit 24. FIG. 17 is a flowchart illustrating an operation of the file determining unit. The flowchart of FIG. 17 illustrates a process for creating a file list of attributes of files used in the past at places the user is scheduled to visit.

[Step S71] The file determining unit 24 acquires the schedule of the user from the scheduler 25, and acquires, from the place information storing unit 22d, place identifiers of places indicated by the schedule that he or she is scheduled to visit.

Note that here the scheduler 25 is used to manage the places scheduled to be visited; however, a system other than the scheduler 25 may be used as long as it allows for acquisition of the places scheduled to be visited.

[Step S72] The file determining unit 24 acquires, from the creation size information in the creation history storing unit 22b, entries each including one of the place identifiers acquired in step S71.

[Step S73] The file determining unit 24 sums the needed sizes included in the entries acquired from the creation size information, and designates the total needed size as free space. Then, the file determining unit 24 subtracts the total needed size (free space) from the storage capacity of the terminal 10 to obtain available storage size of the terminal 10.

Here, the term “free space” refers to the storage volume needed for the user to create files in the past at the places he or she is scheduled to visit. This free space is secured in the terminal 10 in advance. The term “available size” refers to the storage volume provided in the terminal 10, to prestore copied files likely to be used at the places the user is scheduled to visit.

[Step S74] The file determining unit 24 acquires, from the use file list in the usage history storing unit 22c, entries each including one of the place identifiers acquired in step S71.

[Step S75] The file determining unit 24 searches the file storing unit 22a using file paths included in each of the entries acquired from the use file list, and extracts, from the file storing unit 22a, the dates and times and sizes of files having the file paths. Then, the file determining unit 24 uses the extracted dates and times and sizes and the file paths to create a file list as illustrated in FIG. 9.

[Step S76] The file determining unit 24 determines whether the sizes included in the created file list exceed the available size calculated in step S73. In the case where the sizes of the file list exceed the available size, not all files in the file list are allowed to be copied to the terminal 10.

Therefore, the file determining unit 24 deletes some files from the file list so that the sizes included in the file list do not exceed the available size, and then stores the file list in the file list storing unit 26 after the deletion. According to the process up to this point, the file list listing files used in the past at places where the user is scheduled to visit is created and then stored in the file list storing unit 26.

Next described are the free space and the available size, using a specific example. For example, the user is scheduled to visit three places tomorrow. When recognizing the three places according to the user's schedule for tomorrow managed by the scheduler 25, the file determining unit 24 acquires place identifiers each corresponding to one of the three places from the place information storing unit 22d (the place identifiers of the three places are #1, #2, and #3). The file determining unit 24 searches the creation size information stored in the creation history storing unit 22b using the place identifiers #1, #2, and #3, and acquires entries each having one of the place identifiers from the creation size information and checks their needed sizes.

Assume, for example, that the needed size of the entry with the place identifier #1 is 100, that of the entry with the place identifier #2 is 200, and that of the entry with the place identifier #3 is 300. The needed size being 100 is the file volume needed by the user to create one or more files at a time in the past at a place identified by the place identifier #1. The needed size being 200 is the file volume needed by the user to create one or more files at a time in the past at a place identified by the place identifier #2. Similarly, the needed size being 300 is the file volume needed by the user to create one or more files at a time in the past at a place identified by the place identifier #3. Subsequently, the file determining unit 24 adds up the needed sizes included in the acquired entries. In this case, the sum of the needed sizes is 600. The total needed size being 600 is the sum of file volumes that the user needed to create and store files at the three places in the past.

When the user is scheduled to visit these three places tomorrow, it is considered likely that files with a volume of 600 are created when he or she visits the places tomorrow. For this reason, the sum of the needed sizes is calculated as the free space in order to secure the same amount of volume in the terminal 10 in advance. On the other hand, the volume remaining after subtracting the free space from the storage capacity of the terminal 10 is used to store files likely to be used by the user at the places he or she is scheduled to visit. The files are copied to the terminal 10 in advance. The remaining volume in the terminal 10 is referred to as the available size.

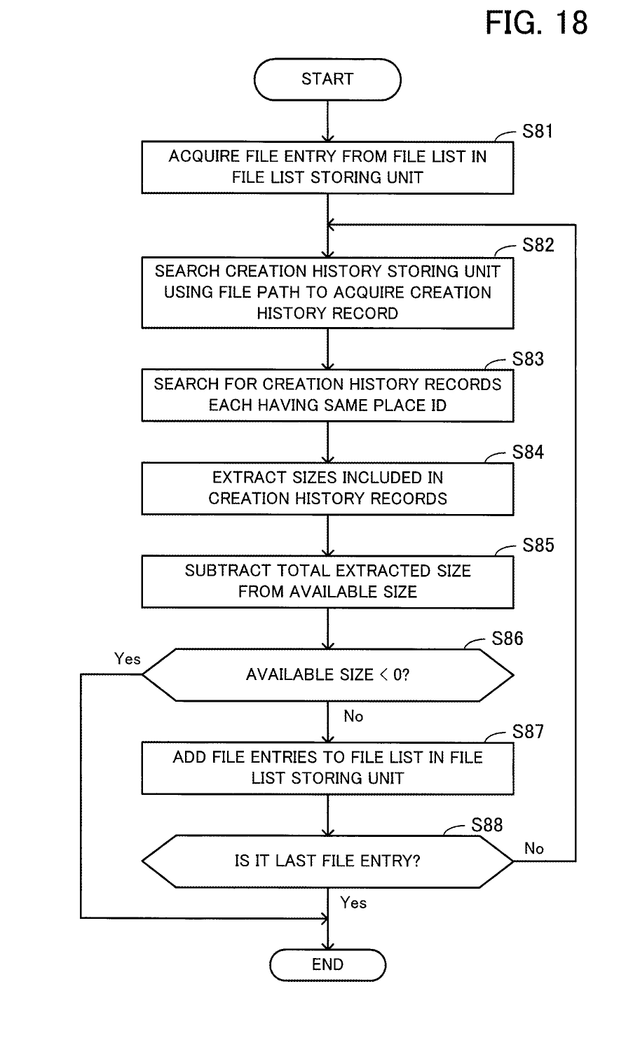

FIG. 18 is a flowchart illustrating another operation of the file determining unit. The flowchart of FIG. 18 illustrates a process for further creating relevant file entries and adding the created file entries to the file list created in FIG. 17. In this regard, the process is performed by taking out file entries in the file list stored in the file list storing unit 26 one at a time. According to the process of FIG. 17, the file list is created by including attributes of files used in the past at places the user is scheduled to visit and then stored in the file list storing unit 26. On the other hand, the process of FIG. 18 is directed to adding, as relevant file entries, files created at the same place as where each used file was created. For example, in the case where a used file was created at a place identified by the place identifier #1, files created at the same place with the place identifier #1 are added, as file entries, to the file list already created in the process of FIG. 17.

[Step S81] The file determining unit 24 acquires a file entry from the file list stored in the file list storing unit 26.

[Step S82] The file determining unit 24 acquires, from the creation history storing unit 22b, a creation history record with the same file path as that included in the acquired file entry.

[Step S83] The file determining unit 24 acquires, from the creation history storing unit 22b, one or more creation history records each having the same place identifier as that included in the creation history record acquired in step S82.

To illustrate this with a specific example, assume that the file path included in the file entry acquired from the file list storing unit 26 is aa. The file determining unit 24 acquires a creation history record with the file path being aa from the creation history storing unit 22b. Assume, for example, that a creation history record with the place identifier #1 and the file path being aa is acquired (the date and time and the size are omitted here). Then, the file determining unit 24 acquires, from the creation history storing unit 22b, one or more creation history records each having the same place identifier as that included in the acquired creation history record but having a different file path. For example, in the case where a creation history record with the place identifier #1 and the file path being bb is present in the creation history storing unit 22b, the file determining unit 24 acquires this creation history record with the file path being bb.

Note that the file determining unit 24 may acquire, from the creation history storing unit 22b, one or more creation history records each having the same combination of the place identifier and the date as those included in the creation history record acquired in step S82. In this case, the file determining unit 24 acquires creation history records of files created at the same place on the same day as the file listed in the file list.

[Step S84] The file determining unit 24 extracts the size included in each of the creation history records acquired in step S83 (according to the above example, the size included in the creation history record with the file path bb).

[Step S85] The file determining unit 24 subtracts the total file size extracted in step S84 from the available size calculated in step S76 of FIG. 17.

[Step S86] The file determining unit 24 determines whether the available size after the subtraction is smaller than zero. If the available size is smaller than zero, the process ends. If not, the process proceeds to step S87.

[Step S87] The file determining unit 24 additionally stores file entries corresponding to the creation history records acquired in step S83 in the file list storing unit 26.

[Step S88] The file determining unit 24 determines whether the file entry currently targeted is the last file entry being the subject of the process. If the file entry is the last one, the process ends. If not, the process returns to step S82.

Note that, in the above example, the file selection is stopped when the available size has reached below zero so as not to select more files than the available size. Alternatively, after files are selected, the selected files may be reduced. In this case, the reduction is based on the frequency of use, the creation date and time, and the use date and time of each file. These information items are added to the use file list when each usage history record is converted. In addition, in converting usage history records, only usage history records with a limited time period may be converted instead of converting all the usage history records, to thereby reduce the number of targeted used files.

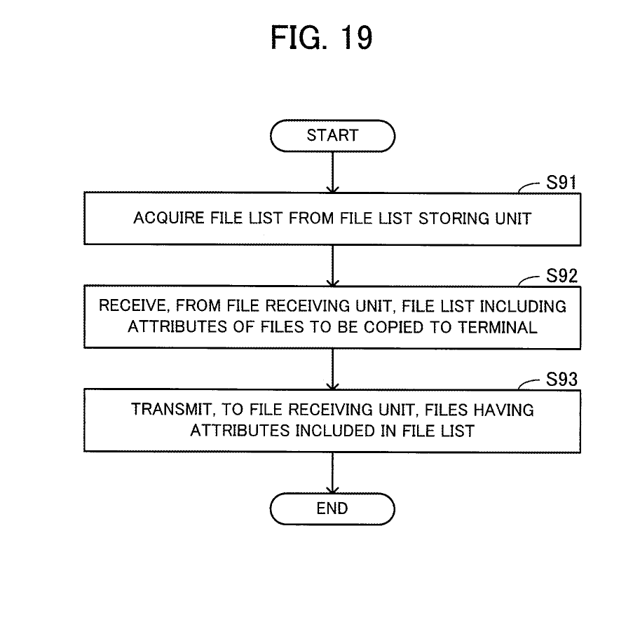

Next described is an operation of the file transmitting unit 27. FIG. 19 is a flowchart illustrating an operation of the file transmitting unit.

[Step S91] The file transmitting unit 27 acquires the file list from the file list storing unit 26 and transmits it to the file receiving unit 14.

[Step S92] The file transmitting unit 27 receives a file list sent back from the file receiving unit 14.

[Step S93] The file transmitting unit 27 acquires, from the file storing unit 22a, files having file attributes indicated in the file list received in step S92 and transmits the files to the file receiving unit 14.

As has been described above, according to the first embodiment, it is possible to secure needed free space in the terminal 10 based on creation and usage history records associated with places that the user is scheduled to visit, and also prepare files likely to be used while the user is visiting the places.

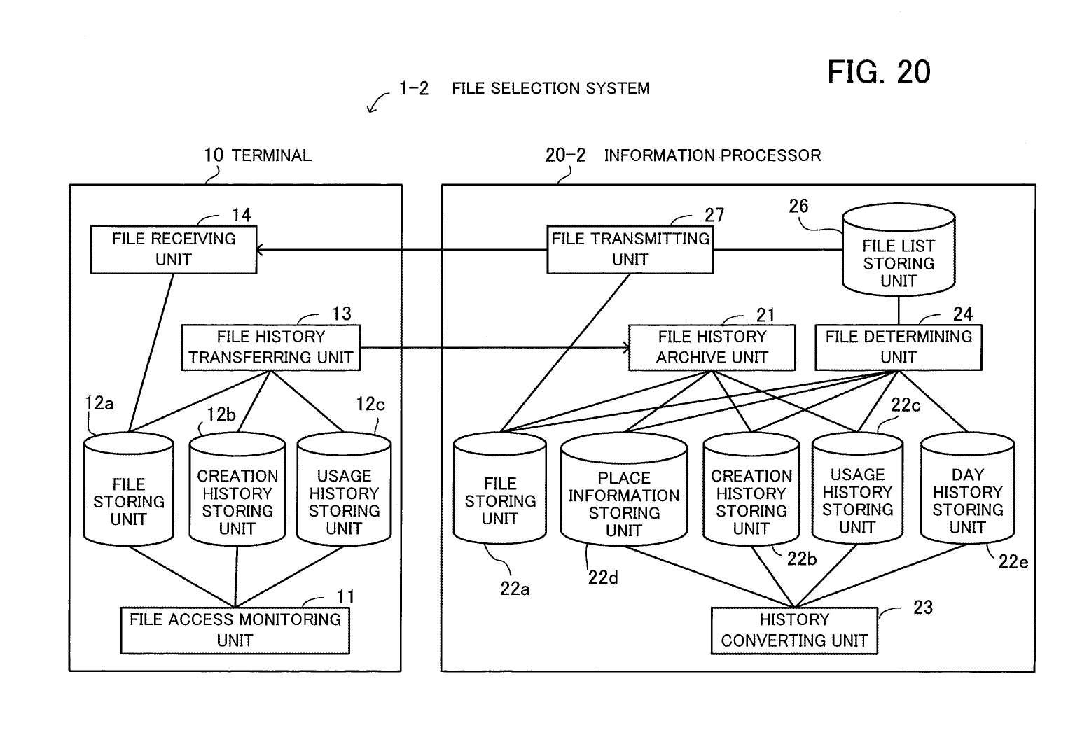

The second embodiment is described next. The second embodiment is directed to predicting places where the user is scheduled to visit based on the history records rather than acquiring them from the scheduler 25. FIG. 20 illustrates a configuration example of a file selection system. A file selection system 1-2 includes the terminal 10 and an information processor 20-2. The configuration example of FIG. 20 is different from that of FIG. 2 in that the information processor 20-2 does not include a scheduler but includes a day history storing unit 22e.

Next described is a method for converting each position to a place according to the second embodiment.

First, the file history archive unit 21 searches the place information stored in the place information storing unit 22d for an entry whose latitude and longitude ranges contain the position indicated by positional information. If the entry is found, the position is converted to a place identifier included in the entry. If such an entry is not found in the place information, the file history archive unit 21 expands the spatial range (i.e., the latitude and longitude ranges) included in an existing entry in four directions to see whether the position indicated by the positional information falls within the expanded spatial range. Then, if only one entry is found, the position is converted to a place identifier included in the entry.

If two or more entries are found in the place information, the file history archive unit 21 creates a new entry integrating these entries and assigns a place identifier to the created entry, and converts the position to the newly assigned place identifier. Yet no entry is found, the file history archive unit 21 creates a new entry and sets an area around the position indicated by the positional information as the spatial range of the newly created entry. Then, the file history archive unit assigns a place identifier to the entry and converts the position to the assigned place identifier.

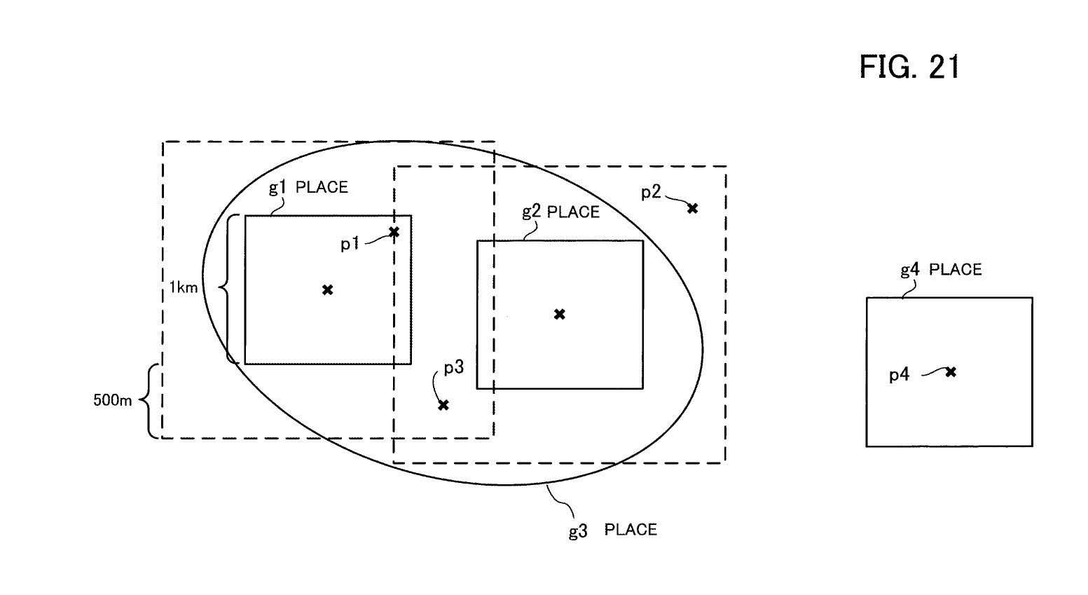

FIG. 21 illustrates conversion from each position to a place. According to the example of FIG. 21, places g1, g2, g3, and g4 are present and each of the places g1, g2, and g4 has an area of 1 square kilometer. The place g3 is formed by integrating the places g1 and g2. Note that the dotted regions represent expanded areas. When the positional information represents a point p1 located in the upper right corner of the place g1, the positional information of the point p1 is converted to the place g1 because the point p1 is located within the place g1. When the positional information represents a point p2 located to the upper right of the place g2, the point p2 is not located within the area of any place but located within the expanded area of the place g2. As a result, the positional information of the point p2 is converted to the place g2.

When the positional information represents a point p3, the point p3 is not located within the area of any place but located within the expanded areas of both the places g1 and g2. As a result, the place g3 is newly created, and the places g1 and g2 are integrated into the place g3. In this case, each of the expanded areas is set by increasing each side of the corresponding place by a half the length of the side (500 meters in this example) in both directions in view of the possibility that the center of the place deviates. Therefore, each expanded area has an area of 2 square kilometers. Note that the place g4 is created by newly setting an area around a point p4, to which a place identifier is then assigned.

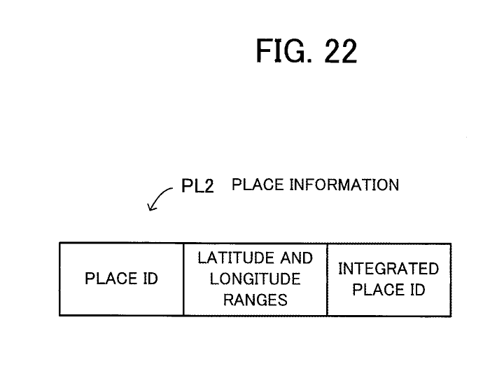

Next described are the data structure of place information and the process of the place information being created according to the second embodiment. FIG. 22 illustrates an example of the data structure of the place information. Place information PL2 of the second embodiment includes attributes of place identifier, latitude and longitude ranges, and integrated place identifier.

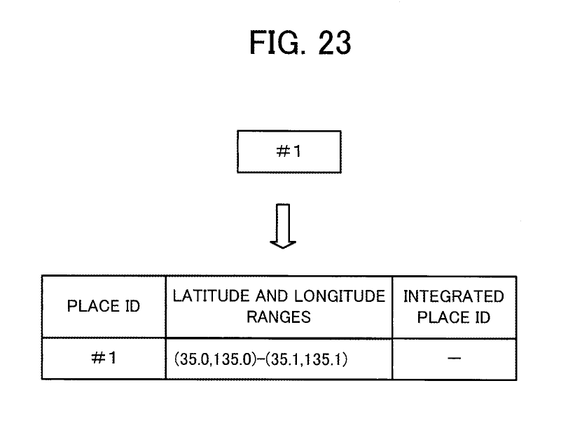

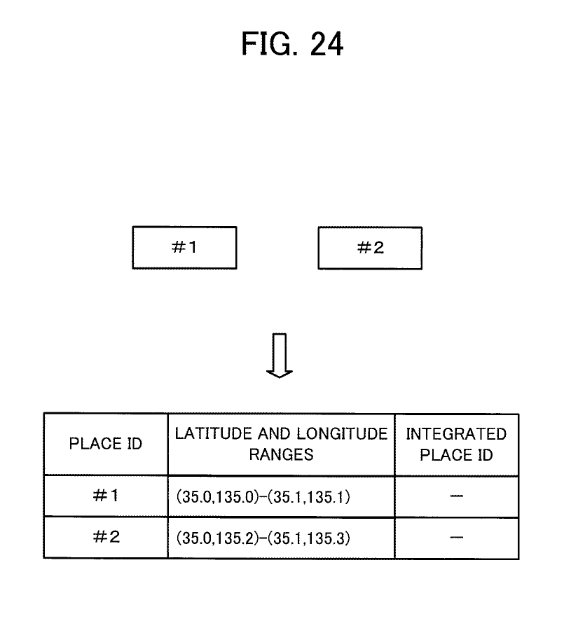

FIGS. 23 to 29 illustrate the process of the place information being created. Assume here that place identifiers are sequentially assigned. Assume in FIG. 23 that a place information entry with a place identifier of #1 is created whose latitude and longitude ranges are 35.0 to 35.1 and 135.0 to 135.1, respectively. At this point in time, a value is not set for the integrated place identifier of the entry. Assume in FIG. 24 that a place information entry with a place identifier of #2 is created whose latitude and longitude ranges are 35.0 to 35.1 and 135.2 to 135.3, respectively. As for the entry with the place identifier #2 also, a value is not set for the integrated place identifier at this point in time.

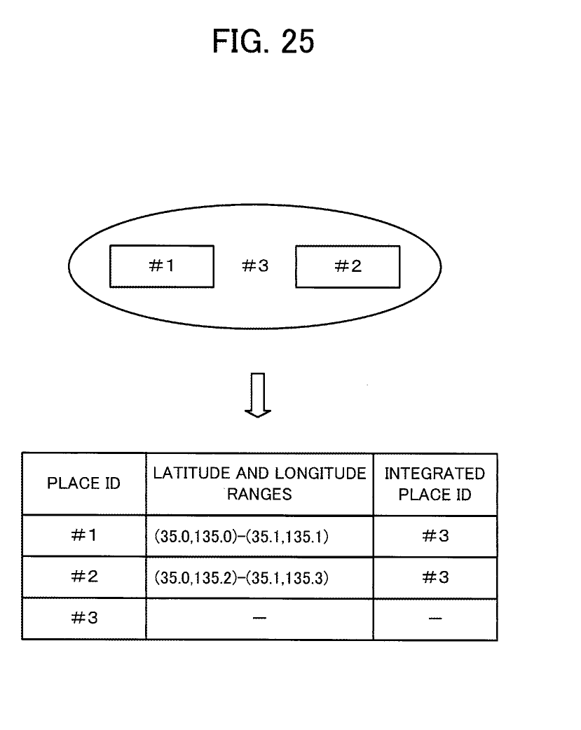

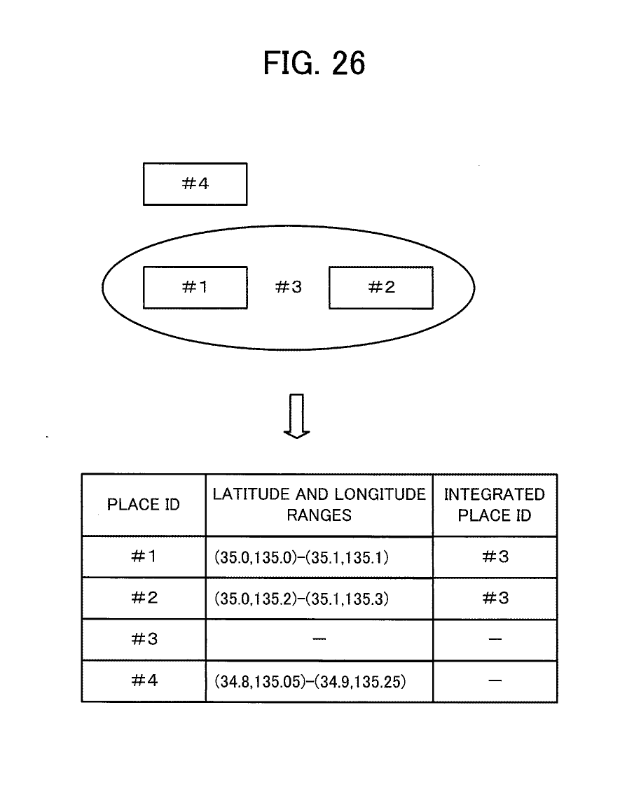

Assume in FIG. 25 that a place information entry with a place identifier of #3 is then created in order to convert a position indicated by positional information, located within the expanded areas of the places with the place identifiers #1 and #2, to a place. At this point in time, the place identifier #3 is assigned as the integrated place identifiers of the entries with the place identifiers #1 and #2. No values are set for the latitude and longitude ranges of the entry with the place identifier #3. In addition, at this point in time, no value is set for the integrated place identifier of the entry with the place identifier #3. Assume in FIG. 26 that a place information entry with a place identifier of #4 is created whose latitude and longitude ranges are 34.8 to 34.9 and 135.05 to 135.25, respectively. At this point in time, no value is set for the integrated place identifier of the entry with the place identifier #4.

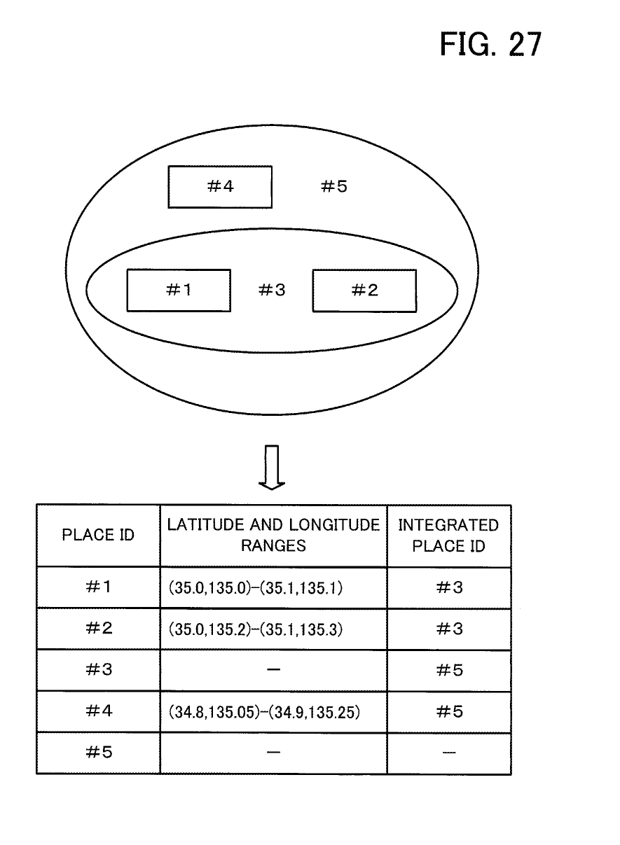

Assume in FIG. 27 that a place information entry with a place identifier of #5 is created in order to convert a position indicated by positional information, located within the expanded areas of the places with the place identifiers #1 and #4, to a place. Alternatively, the place information entry with the place identifier #5 is created in order to convert a position indicated by positional information, located within the expanded areas of the places with the place identifiers #2 and #4, to a place. Alternatively, the place information entry with the place identifier #5 is created in order to convert a position indicated by positional information, located within the expanded areas of the places with the place identifiers #1, #2, and #4, to a place. In this case, the place identifier #5 is assigned as the integrated place identifiers of the entries with the place identifiers #3 and #4. Note that no values are set for the latitude and longitude ranges of the entry with the place identifier #5. In addition, at this point in time, no value is set for the integrated place identifier of the entry with the place identifier #5.

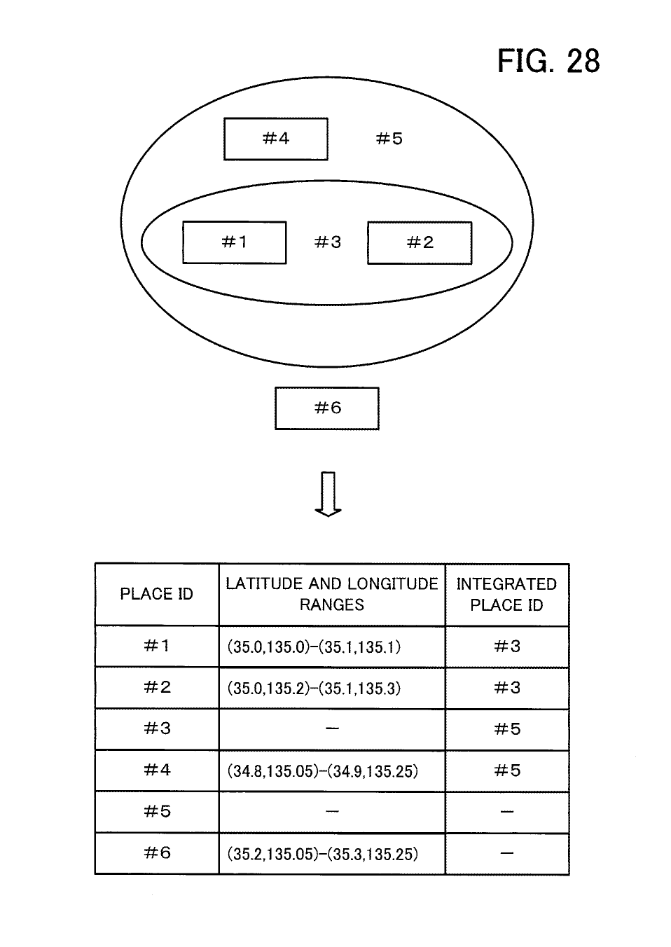

Assume in FIG. 28 that a place information entry with a place identifier of #6 is created whose latitude and longitude ranges are 35.2 to 35.3 and 135.05 to 135.25, respectively. At this point in time, no value is set for the integrated place identifier of the entry with the place identifier #6.

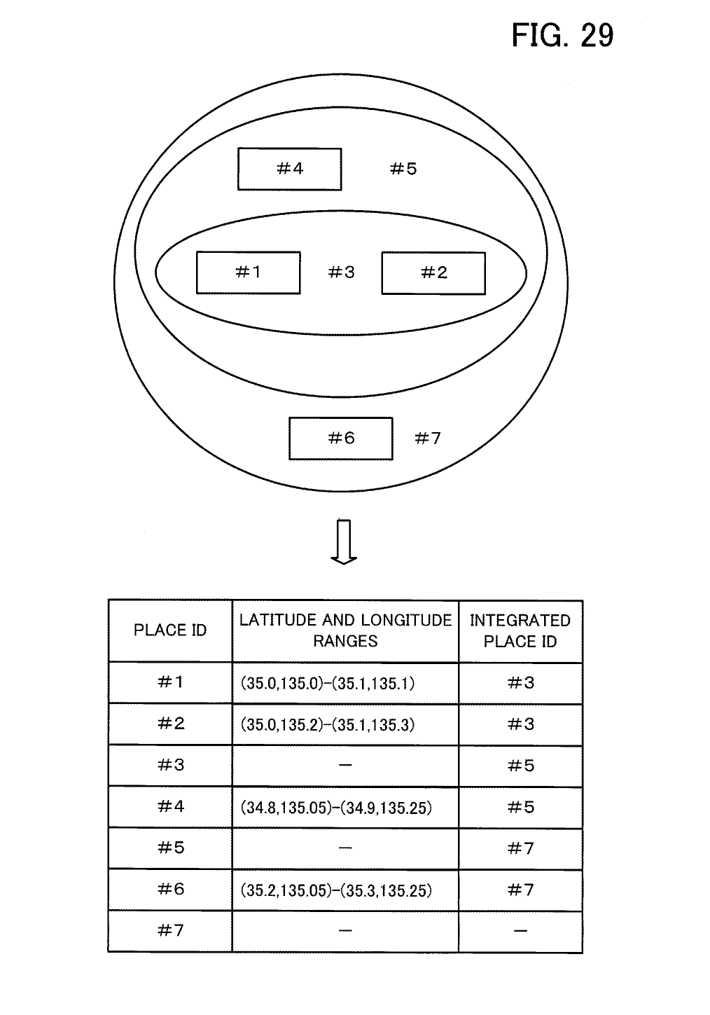

Assume in FIG. 29 that a place information entry with a place identifier of #7 is created in order to convert a position indicated by positional information, located within the expanded areas of the places with the place identifiers #1 and #6, to a place. Alternatively, the place information entry with the place identifier #7 is created in order to convert a position indicated by positional information, located within the expanded areas of the places with the place identifiers #2 and #6, to a place.

Alternatively, the place information entry with the place identifier #7 is created in order to convert a position indicated by positional information, located within the expanded areas of the places with the place identifiers #4 and #6, to a place. Alternatively, the place information entry with the place identifier #7 is created in order to convert a position indicated by positional information, located within the expanded areas of the places with the place identifiers #1, #2, and #6, to a place.

Alternatively, the place information entry with the place identifier #7 is created in order to convert a position indicated by positional information, located within the expanded areas of the places with the place identifiers #1, #4, and #6, to a place. Alternatively, the place information entry with the place identifier #7 is created in order to convert a position indicated by positional information, located within the expanded areas of the places with the place identifiers #2, #4, and #6, to a place. Alternatively, the place information entry with the place identifier #7 is created in order to convert a position indicated by positional information, located within the expanded areas of the places with the place identifiers #1, #2, #4, and #6, to a place.

In this case, the place identifier #7 is assigned as the integrated place identifiers of the entries with the place identifiers #5 and #6. Note that no values are set for the latitude and longitude ranges of the entry with the place identifier #7. In addition, at this point in time, no value is set for the integrated place identifier of the entry with the place identifier #7.

The integrated place identifiers are set in the above-described manner. As for each place information entry with a value being set for its integrated place identifier, an actual place identifier of the entry is found as follows. Referring to the entry with a value being set for its integrated place identifier as a first entry in an easy-to-understand manner, the integrated place identifier of the first entry is checked. Then, a second entry is found whose place identifier is the integrated place identifier of the first entry. Next, the integrated place identifier of the second entry is checked. Then, a third entry is found whose place identifier is the integrated place identifier of the second entry. Thus, entries are sequentially followed until an entry with no value being set for its integrated place identifier is reached. The place identifier of this entry with no value being set for its integrated place identifier is used as the actual place identifier of the first entry.

Illustrating this according to the example above, in the case of the place information entry with the place identifier #1, its integrated place identifier is #3 and, therefore, the integrated place identifier of the entry with the place identifier #3 is checked. Here, the integrated place identifier is #5. Then, the integrated place identifier of the entry with the place identifier #5 is checked. Here, the integrated place identifier is #7. Further, the integrated place identifier of the entry with the place identifier #7 is checked. Since the entry with the place identifier #7 does not have a value for the integrated place identifier, the place identifier #7 is the actual place identifier of the entry with the place identifier #1.

Next described is the operation of the history converting unit 23 according to the second embodiment. The creation and usage history conversion processes of the history converting unit 23 are basically the same as illustrated in FIGS. 15 and 16; however, in the processes according to the second embodiment, integrated place identifiers are used in place of the place identifiers. In the conversion processes, as described above, if a corresponding place information entry has a value set for its integrated place identifier, an entry with the place identifier being the value of the integrated place identifier is found. Then, if the found entry also has a value set for its integrated place identifier, an entry with the place identifier being the value of the integrated place identifier is found. In such a manner, when an entry with no value being set for its integrated place identifier is found, the place identifier of the entry is determined as the actual place identifier of the original entry.

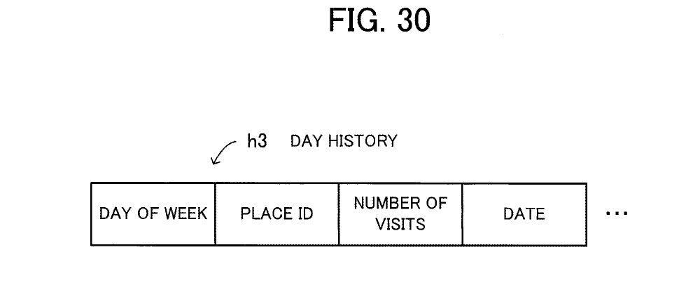

On the other hand, the history converting unit 23 performs day history conversion. In the day history conversion, only history records regarding days of the week are taken out from usage and creation history records, and information indicating how often each place was visited on each day of the week is extracted. FIG. 30 illustrates an example of the data structure of a day history. A day history h3 includes attributes of day of the week, place identifier, number of visits, and date. The day history h3 is data representing how many times the user has visited each place on each day of the week and also indicating dates of the visits.

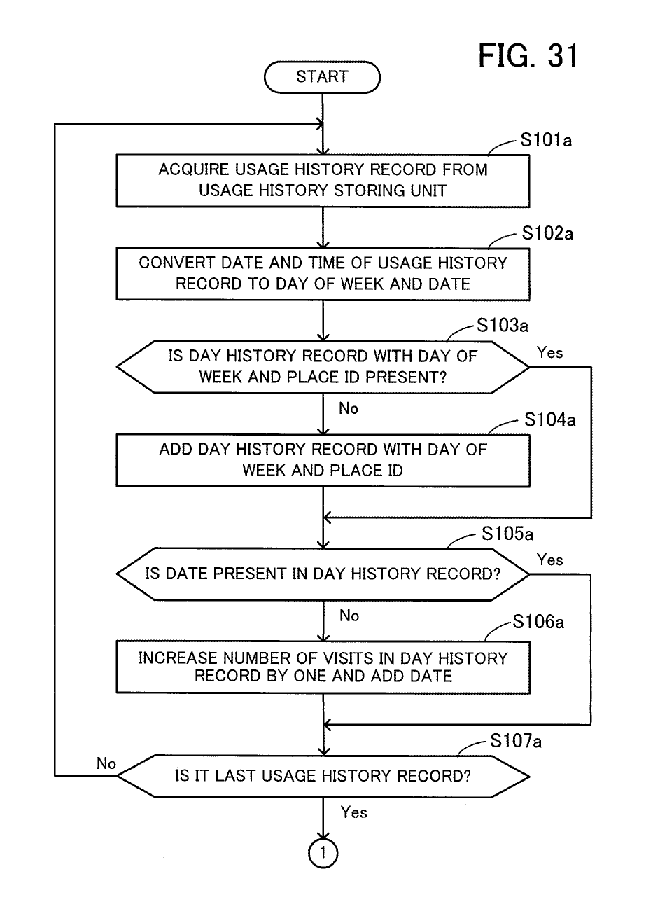

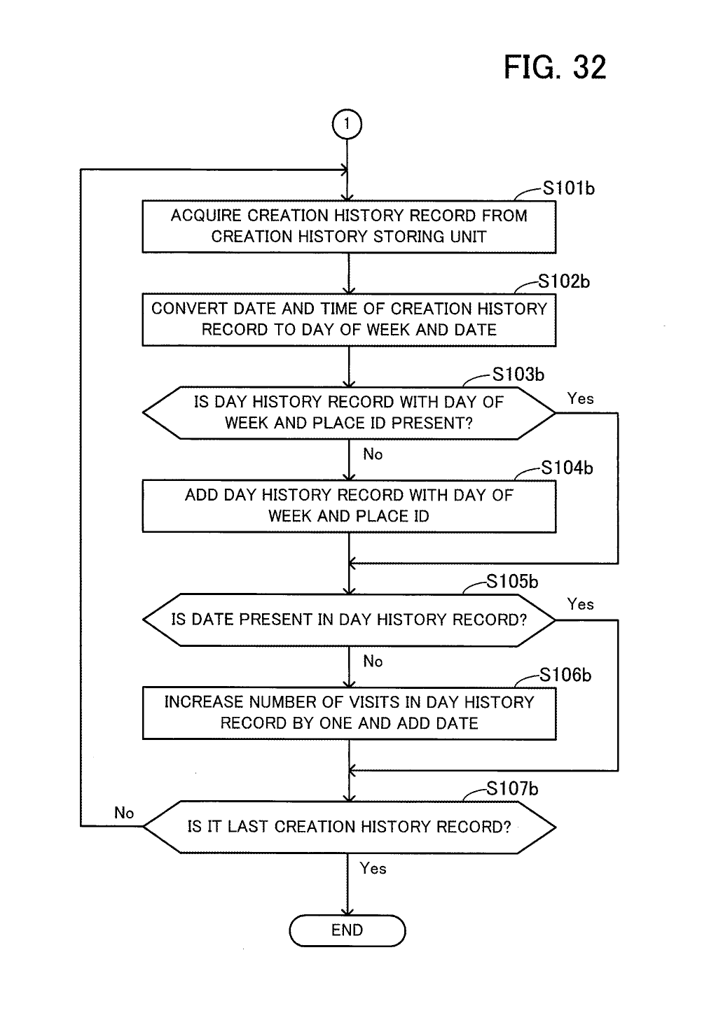

FIGS. 31 and 32 are flowcharts illustrating an operation of the history converting unit for the day history conversion.

[Step S101a] The history converting unit 23 acquires a usage history record from the usage history storing unit 22c.

[Step S102a] The history converting unit 23 converts the date and time of the usage history record to a day of the week and a date.

[Step S103a] The history converting unit 23 determines whether a day history record with the day converted in step S102a and the place identifier included in the usage history record is present in the day history record storing unit 22e. If it is absent, the operation proceeds to step S104a. On the other hand, if it is present, the operation proceeds to step S105a.

[Step S104a] When the day history record is absent, the history converting unit 23 newly creates a day history record by setting the day of the week and the place identifier.

[Step S105a] The history converting unit 23 determines whether the date converted in step S102a is set in the day history record. If the date is not set in the day history record, the operation proceeds to step S106a. On the other hand, if the date is set, the operation proceeds to step S107a.

[Step S106a] The history converting unit 23 increases the number of visits in the day history record by one, and adds the date converted from the date and time included in the usage history record to a field of the date in the day history record.

[Step S107a] The history converting unit 23 determines whether all usage history records have undergone the above process. If the usage history record currently targeted is the last one, the operation proceeds to step S101b. If not, the operation returns to step S101a.

[Step S101b] The history converting unit 23 acquires a creation history record from the creation history storing unit 22b.

[Step S102b] The history converting unit 23 converts the date and time of the creation history record to a day of the week and a date.

[Step S103b] The history converting unit 23 determines whether a day history record with the day converted in step S102b and the place identifier included in the creation history record is present in the day history record storing unit 22e. If it is absent, the operation proceeds to step S104b. On the other hand, if it is present, the operation proceeds to step S105b.

[Step S104b] When the day history record is absent, the history converting unit 23 newly creates a day history record by setting the day of the week and the place identifier.

[Step S105b] The history converting unit 23 determines whether the date converted in step S102b is set in the day history record. If the date is not set in the day history record, the operation proceeds to step S106b. On the other hand, if the date is set, the operation proceeds to step S107b.

[Step S106b] The history converting unit 23 increases the number of visits in the day history record by one, and adds the date converted from the date and time included in the creation history record to a field of the date in the day history record.

[Step S107b] The history converting unit 23 determines whether all creation history records have undergone the above process. If the creation history record currently targeted is the last one, the operation ends. If not, the operation returns to step S101b.

In the day conversion, visiting the same place on the same date even more than once is still counted as one visit according to the second embodiment. In addition, no differentiation is made for file creation and usage in the day conversion, and even if a file is created and used on the same date, it is still counted as one. Note however that file creation and usage may be counted separately. In addition, the number of visits may be counted for each date so that visited places are weighted according to the number of visits, which allows for selection of places to be visited. Note that the day history conversion uses integrated place identifiers in place of place identifiers as with the case above.

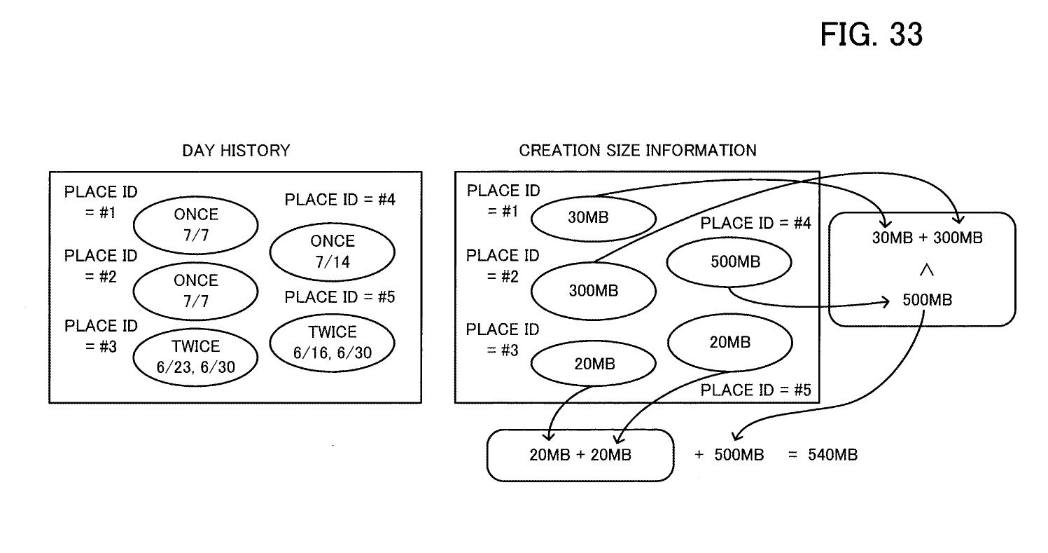

Next described is a free space calculation process according to the second embodiment. FIG. 33 illustrates a free space calculation process. Assume that the user visited five places on separate Mondays. Specifically, assume that the user visited once at the place with the place identifier #1 on Monday, July 7; the user visited once at the place with the place identifier #2 on Monday, July 7; the user visited twice in total at the place with the place identifier #3 on Monday, June 23 and 30; the user visited once at the place with the place identifier #4 on Monday, July 14; and the user visited twice in total at the place with the place identifier #5 on Monday, June 16 and 30. On the other hand, the needed sizes included in the creation size information, corresponding to the place identifiers #1 to #5 are 30 MB, 300 MB, 20 MB, 500 MB, and 20 MB, respectively. Each of these values indicates a file volume needed to create files at the corresponding place.

As for place identifiers with the number of visits being two or more, like the place identifiers #3 and #5, their needed sizes are combined. Since the needed sizes corresponding to the place identifiers #3 and #5 are both 20 MB, the combined value is 40 MB. As for place identifiers with the number of visits being only one, like the place identifiers #1, #2, and #4, if places were visited on the same date, their corresponding needed sizes of the date are combined. The places identified by the place identifiers #1 and #2 were visited on the same date, and the needed sizes, 30 MB and 300 MB, corresponding to the place identifiers #1 and #2, respectively, amount to 330 MB.

For the places the user visited only once, it is assumed that the user may visit either the places with the place identifiers #1 and #2 or the place with the place identifier #4 if at all. Therefore, a larger one of the needed sizes is selected. According to the example, because the combined needed size corresponding to the place identifiers #1 and #2 is 330 MB and the needed size corresponding to the place identifier #4 is 500 MB, the needed size of the place identifier #4 is selected. As a result, the free space secured in the terminal 10 for the user to create files at places he or she is scheduled to visit on Monday is calculated to be 540 MB (=40 MB+500 MB).

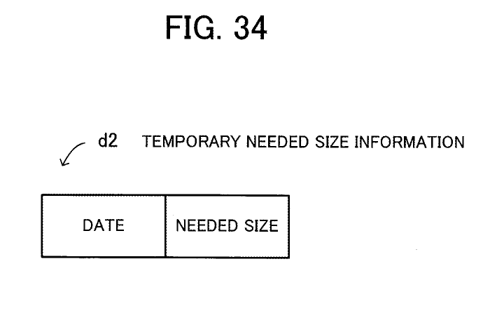

Next described is the operation of the file determining unit 24 to calculate the free space described above. The file determining unit 24 uses, as temporary variables, a free size (zero at the start of the process) to calculate finally needed free space and a temporary needed size used to store needed sizes for places each visited only once. FIG. 34 illustrates an example of the data structure of temporary needed size information. Temporary needed size information d2 includes attributes of date and needed size.

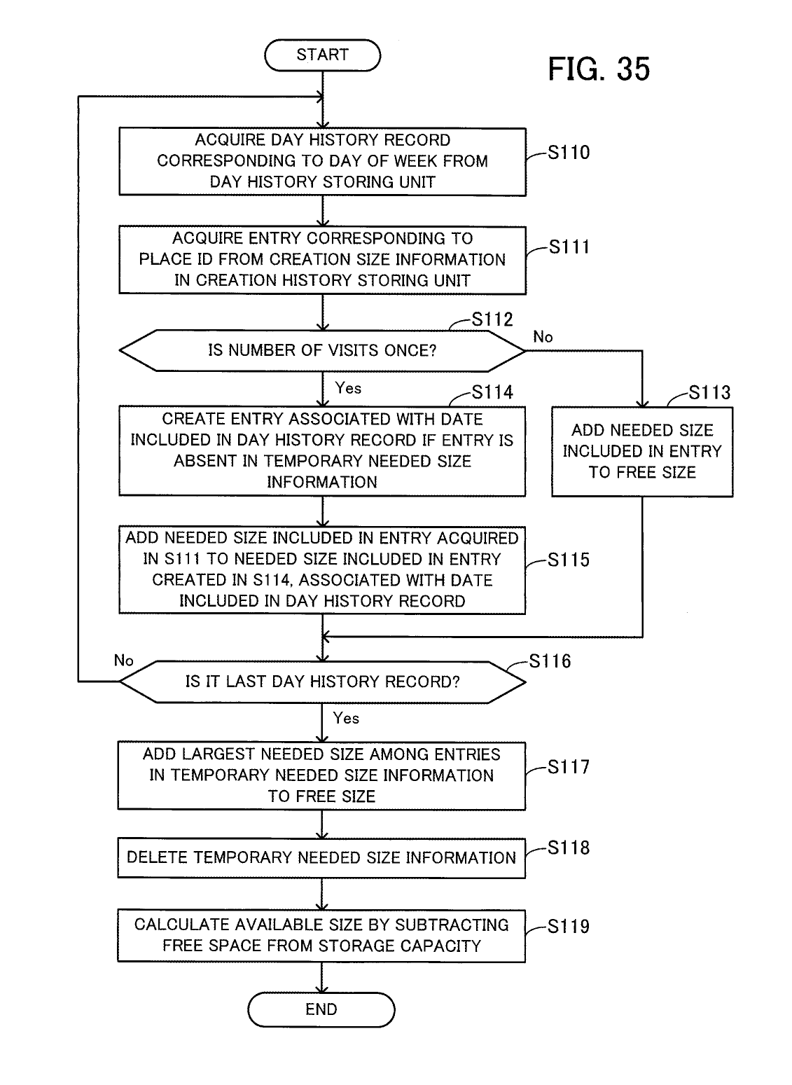

FIG. 35 is a flowchart illustrating an operation of the file determining unit for primarily calculating the free space.

[Step S110] The file determining unit 24 acquires, from the day history storing unit 22e, a day history record corresponding to a particular day of the week (for example, a day history record of Monday).

[Step S111] The file determining unit 24 acquires, from the creation size information in the creation history storing unit 22b, an entry corresponding to the place identifier included in the acquired day history record.

[Step S112] The file determining unit 24 determines whether the number of visits included in the day history record is one. If the number of visits is two or more, the operation proceeds to step S113. On the other hand, if the number of visits is one, the operation proceeds to step S114.

[Step S113] When the number of visits is two or more, the file determining unit 24 adds the needed size included in the entry acquired in step S111 to the free size.

[Step S114] When the number of visits is one, the file determining unit 24 acquires, from the temporary needed size information d2, an entry associated with the date included in the day history record. If such an entry is absent, the file determining unit 24 creates the entry.

[Step S115] The file determining unit 24 adds the needed size included in the entry acquired in step S111 to the needed size included in the entry acquired or created in step S114, associated with the date included in the day history record.

[Step S116] The file determining unit 24 determines whether all day history records corresponding to the particular day of the week have undergone the above process. If the day history record currently targeted is the last one, the operation proceeds to step S117. If not, the operation returns to step S110.

[Step S117] The file determining unit 24 selects, amongst created entries in the temporary needed size information d2, one with the largest needed size, and then adds the selected needed size to the free size.

[Step S118] The file determining unit 24 deletes the temporary needed size information d2. What is calculated in the above process is the free space to be secured in the terminal 10.

[Step S119] The file determining unit 24 subtracts the free space from the storage capacity of the terminal 10 to thereby obtain the available size.

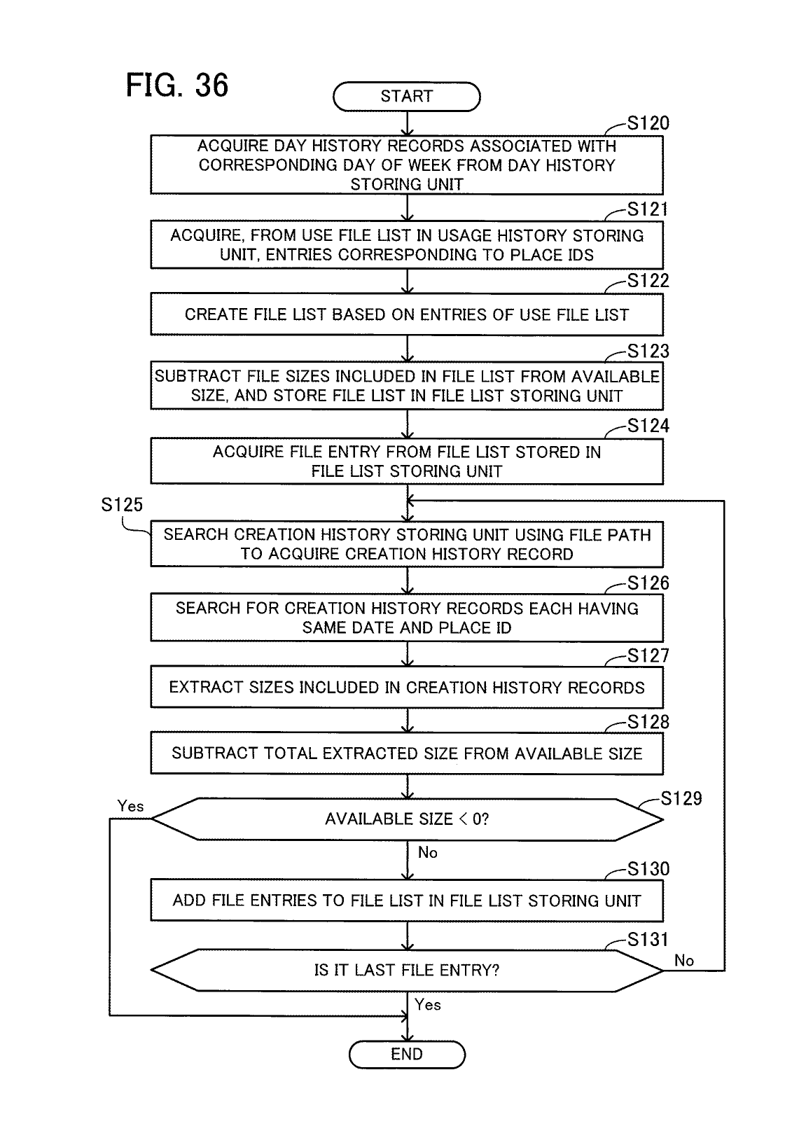

FIG. 36 is a flowchart illustrating an operation of the file determining unit for selecting files.

[Step S120] The file determining unit 24 acquires day history records associated with a corresponding day of the week from the day history storing unit 22e.

[Step S121] The file determining unit 24 acquires, from the use file list in the usage history storing unit 22c, entries each corresponding to one of place identifiers included in the acquired day history records.

[Step S122] The file determining unit 24 searches the file storing unit 22a using file paths included in each of the entries acquired from the use file list, and extracts, from the file storing unit 22a, the dates and times and sizes of files having the file paths. Then, the file determining unit 24 uses the extracted dates and times and sizes and the file paths to create a file list as illustrated in FIG. 9.

[Step S123] The file determining unit 24 determines whether the sizes included in the created file list exceed the available size calculated in step S119 of FIG. 35. In the case where the sizes of the file list exceed the available size, not all files in the file list are allowed to be copied to the terminal 10.

Therefore, the file determining unit 24 deletes some files from the file list so that the sizes included in the file list do not exceed the available size, and then stores the file list in the file list storing unit 26 after the deletion.

[Step S124] The file determining unit 24 acquires a file entry from the file list stored in the file list storing unit 26.

[Step S125] The file determining unit 24 acquires, from the creation history storing unit 22b, a creation history record with the same file path as that included in the acquired file entry.

[Step S126] The file determining unit 24 acquires, from the creation history storing unit 22b, one or more creation history records each having the same date and place identifier as those included in the creation history record acquired in step S125.

[Step S127] The file determining unit 24 extracts the size included in each of the acquired creation history records.

[Step S128] The file determining unit 24 subtracts the total file size extracted in step S127 from the available size.

[Step S129] The file determining unit 24 determines whether the available size is smaller than zero after the subtraction. If the available size is smaller than zero, the process ends. If not, the process proceeds to step S130.

[Step S130] The file determining unit 24 additionally stores file entries corresponding to the creation history records acquired in step S126 in the file list storing unit 26.

[Step S131] The file determining unit 24 determines whether the file entry currently targeted is the last file entry being the subject of the process. If the file entry is the last one, the process ends. If not, the process returns to step S125.

Note that the above describes the method for estimating places likely to be visited on a particular day of the week using past history records associated with the day of the week. Instead, the place estimation may be made using past history records associated with, for example, the second Monday of the month, a particular day of each month, or public holidays. Using past history records associated with the second Monday of month or a particular day of each month is essentially using monthly trends for the place estimation, and using past history records associated with public holidays is basically using trends different from those of regular weekends off for the place estimation.

Further, weather elements may be employed for the place estimation. In this case, in the usage and creation history conversion, information on the weather in a corresponding place is needed to be acquired and stored in each usage or creation history record. To acquire the information on the weather in a place, a Web service released to the public is used, for example. Using past history records associated with the weather is essentially using trends much affected by the weather (for example, outdoors if the weather is good and indoors if it rains) for the place estimation (the operation of using weather history records for the place estimation is described later as a modification).

As has been described above, it is possible to secure needed free space in the terminal 10 based on creation and usage history records associated with places the user is scheduled to visit, and also prepare files likely to be used while the user is visiting the places. Unlike the first embodiment, the second embodiment is able to determine files to be prepared by estimating places likely to be visited based on past history records even when information on places to be visited is not available from a scheduler or the like.

Next described is a third embodiment. The third embodiment is directed to allowing files created by devices other than the terminal 10 to also be taken out from the information processor based on the association of the files. According to the first and the second embodiments, files created on the terminal 10 are sent from the information processors 20 and 20-1 and taken out when the user is going to visit places.

On the other hand, the third embodiment allows the terminal 10 to take out files other than those created on the terminal 10. For example, in the case where files of photos taken by a digital camera are stored in the information processor, the files created by the digital camera, other than the terminal 10, are allowed to be copied to the terminal 10. In this regard, for example, when the face of a person on a photo taken by the terminal also appears on a photo taken by the digital camera, the file of the photo taken by the digital camera is considered as a relevant file, and the file is allowed to be copied to the terminal 10.

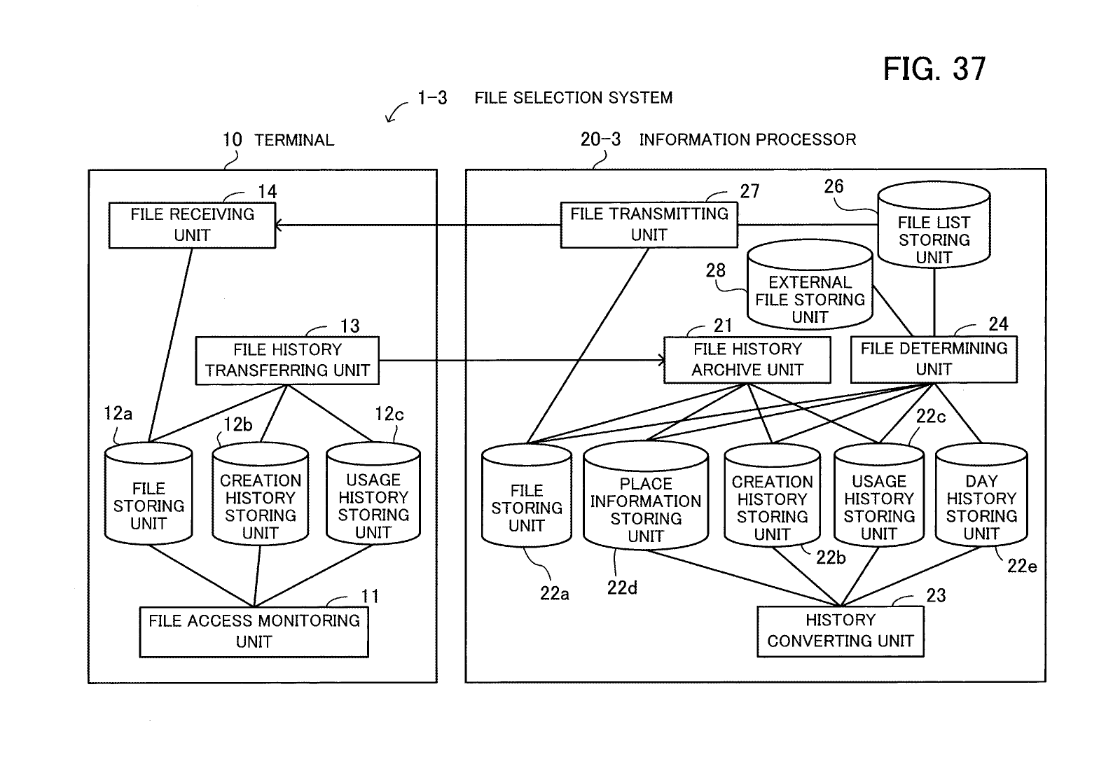

FIG. 37 illustrates a configuration example of a file selection system according to the third embodiment. A file selection system 1-3 includes the terminal 10 and an information processor 20-3. The configuration example of FIG. 37 is different from that of FIG. 20 in that the information processor 20-3 additionally includes an external file storing unit 28. The external file storing unit 28 is a storage area for files other than those created on the terminal 10.

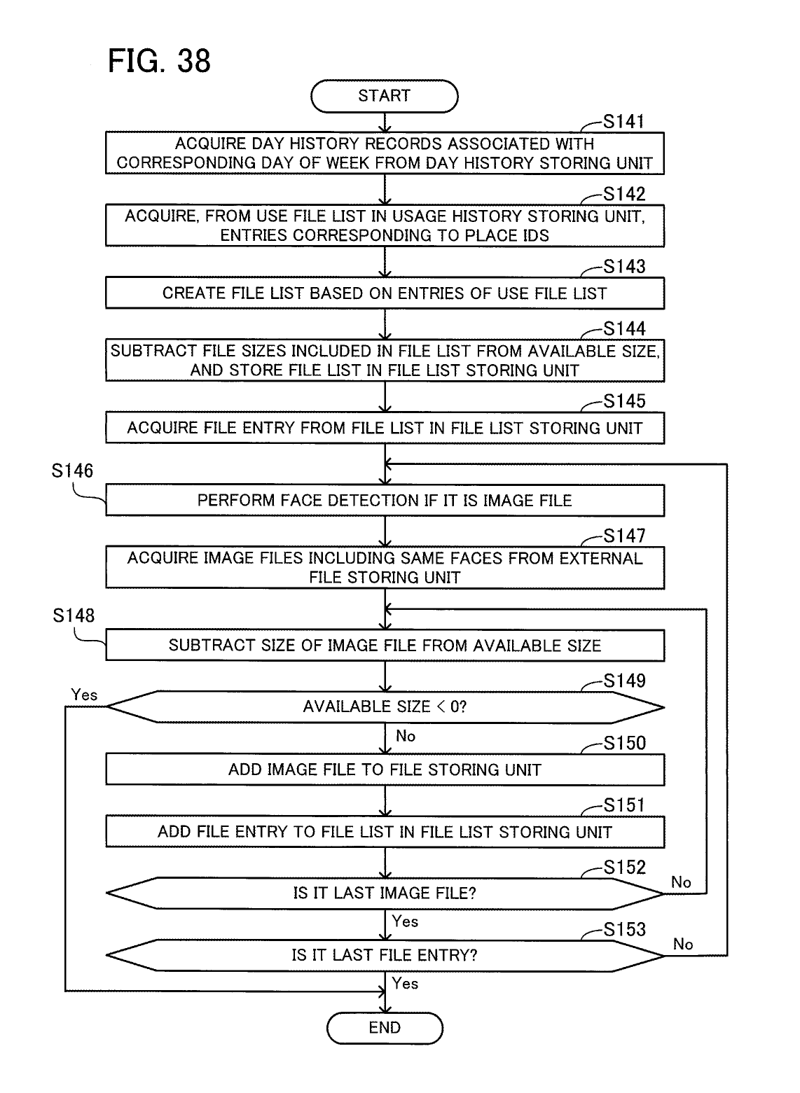

FIG. 38 is a flowchart illustrating an operation of the file determining unit for selecting files. Note that the operation of the file determining unit 24 for calculating the free space according to the third embodiment is the same as that illustrated in FIG. 35.

[Step S141] The file determining unit 24 acquires all day history records associated with a corresponding day of the week from the day history storing unit 22e.

[Step S142] The file determining unit 24 acquires, from the use file list in the usage history storing unit 22c, entries each corresponding to one of place identifiers included in the acquired day history records.

[Step S143] The file determining unit 24 searches the file storing unit 22a using file paths included in each of the entries acquired from the use file list, and extracts, from the file storing unit 22a, the dates and times and sizes of files having the file paths. Then, the file determining unit 24 uses the extracted dates and times and sizes and the file paths to create a file list as illustrated in FIG. 9.

[Step S144] The file determining unit 24 determines whether the sizes included in the created file list exceed the available size calculated in step S119 of FIG. 35. In the case where the sizes of the file list exceed the available size, not all files in the file list are allowed to be copied to the terminal 10.

Next, the file determining unit 24 performs a process of further adding relevant files to the created file list. For the sake of simplicity, the operation described here omits the process of adding relevant files obtained from the file storing unit 22a, illustrated in FIG. 36, and includes only a process of adding relevant files obtained from the external file storing unit 28. Note however that the process of adding relevant files obtained from the file storing unit 22a may be incorporated into the operation. The file determining unit performs the following process by taking out file entries from the file list stored in the file list storing unit 26 one at a time.

[Step S145] The file determining unit 24 acquires a file entry from the file list stored in the file list storing unit 26.

[Step S146] The file determining unit 24 determines, based on the extension of the file path included in the file entry, whether the file entry is associated with an image file. If the file entry is associated with an image file, the file determining unit 24 acquires the file from the file storing unit 22a, and detects the degree of matching on the image. The detection of the degree of matching is, for example, face detection.

[Step S147] The file determining unit 24 acquires, from the external file storing unit 28, one or more image files including faces detected in step S146 (there are existing techniques for detecting faces and searching for images including particular faces, and no description on the methods are therefore given herein).

[Step S148] The file determining unit 24 processes the acquired image files one at a time. First, the file determining unit 24 subtracts the size of the image file from the available size.

[Step S149] The file determining unit 24 determines whether the available size is smaller than zero after the subtraction. If the available size is smaller than zero, the process ends because no more files are allowed to be stored in the terminal 10. On the other hand, if the available size is not smaller than zero, the process proceeds to step S150.

[Step S150] The file determining unit 24 stores the image file in the file storing unit 22a.

[Step S151] The file determining unit 24 adds, to the file list in the file list storing unit 26, a file entry of the image file together with a file path created when the image file is stored in step S150.

[Step S152] The file determining unit 24 determines whether the image file currently targeted is the last one of the image files acquired in step S147. If it is the last image file, the operation proceeds to step S153. If not, the operation returns to step S148.

[Step S153] The file determining unit 24 determines whether the file entry currently targeted is the last file entry being the subject of the process of adding relevant files. If the file entry is the last one, the operation of the file determining unit 24 ends. If not, the operation returns to step S146.

The above example illustrates a method for stopping the file selection when the available size becomes smaller than zero so that files are not selected more than the available size. Other than employing the file reduction described in the first embodiment, files to be selected may be reduced using the degree of face matching obtained in the face detection as a measure of file selection. The number of faces matching or the number of faces matching to the total number of faces is, for example, used as the degree of matching, and images are considered as matching when such a parameter exceeds a predetermined threshold. In addition, not only faces but also landscapes and physical objects may be detected on images by image recognition, and files of the images may be extracted as relevant files. According to the third embodiment, files other than those created on the terminal 10 are allowed to be taken out when the user is going to visit places.

Next described is a fourth embodiment. According to the first and second embodiments, files are selected based on places the user actually visited in the past. On the other hand, the fourth embodiment is directed to giving places meaning and regarding places relevant to those predicted to be visited as places having the potential to be visited regardless of days of the week. For example, assume that the user visited a theater in a place in the past. In this case, the user is able to watch a movie at a theater in a different place rather than going back to the same theater. Thus, places the user has not actually visited before are also considered as relevant places.

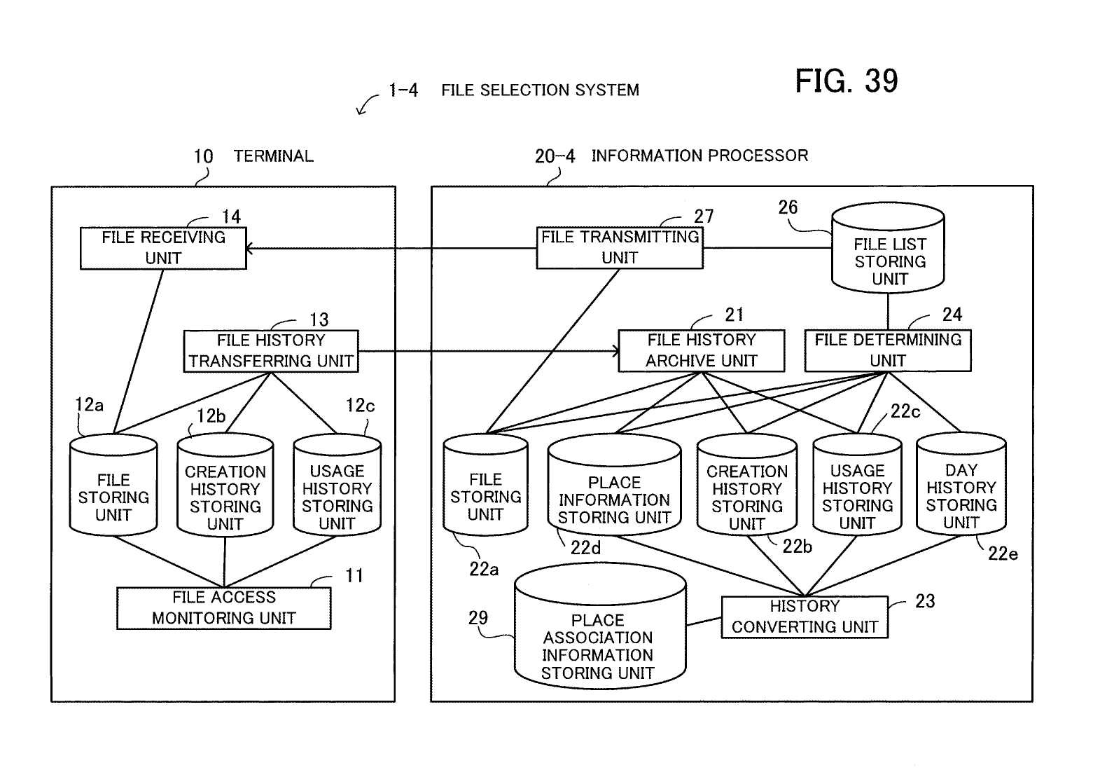

FIG. 39 illustrates a configuration example of a file selection system according to the fourth embodiment. A file selection system 1-4 includes the terminal 10 and an information processor 20-4. The configuration example of FIG. 39 is different from that of FIG. 20 in that the information processor 20-4 includes a place association information storing unit 29. The place association information storing unit 29 holds the relationship among places.

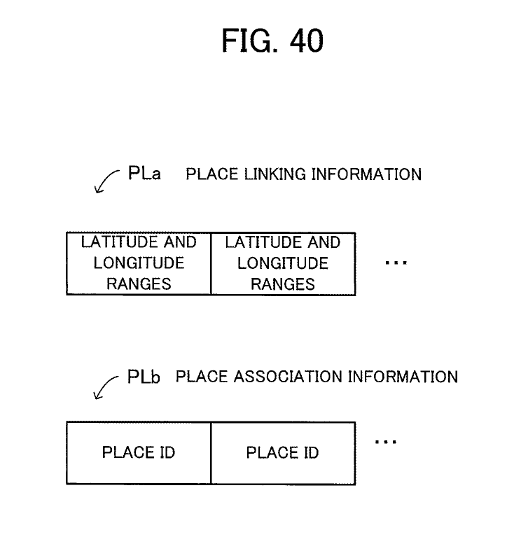

FIG. 40 illustrates an example of data structures of data stored in the place association information storing unit. The place association information storing unit 29 stores therein place linking information PLa and place association information PLb. The place linking information PLa includes attributes of latitude and longitude ranges, for example, latitude and longitude ranges of Theater A and latitude and longitude ranges of Theater B. The place association information PLb includes attributes of place identifiers.

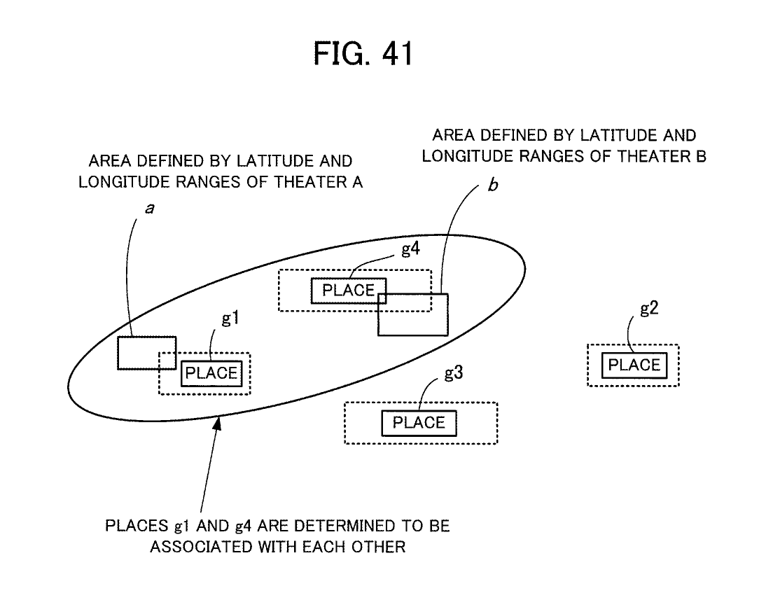

FIG. 41 illustrates an operation for setting place identifiers of place association information. The history converting unit 23 searches whether there are overlaps between areas defined by latitude and longitude ranges included in each entry of the place linking information and areas defined by latitude and longitude ranges included in the place information. As for each overlap, the place identifier of the entry of the place information is set as a place identifier included in the place association information. Note that, to find the overlaps, the search above uses the expanded area of each of the areas defined by latitude and longitude ranges included in the place information.

To illustrate this with a specific example of FIG. 41, assume here that place information including entries each corresponding to one of places g1 to g4 has already been obtained. The dotted region around each of the places g1 to g4 in FIG. 41 represents the expanded area of the place. An area a defined by the latitude and longitude ranges of Theater A partially overlaps the expanded area of the place g1. In addition, an area b defined by the latitude and longitude ranges of Theater B partially overlaps the expanded area of the place g4. As a result, the places g1 and g4 are determined to be associated with each other. Then, the place identifiers of the places g1 and g4 are converted to one eventually obtained after following integrated place identifiers in the above-described manner. The association of the places established in this manner is stored in the place association information PLb.

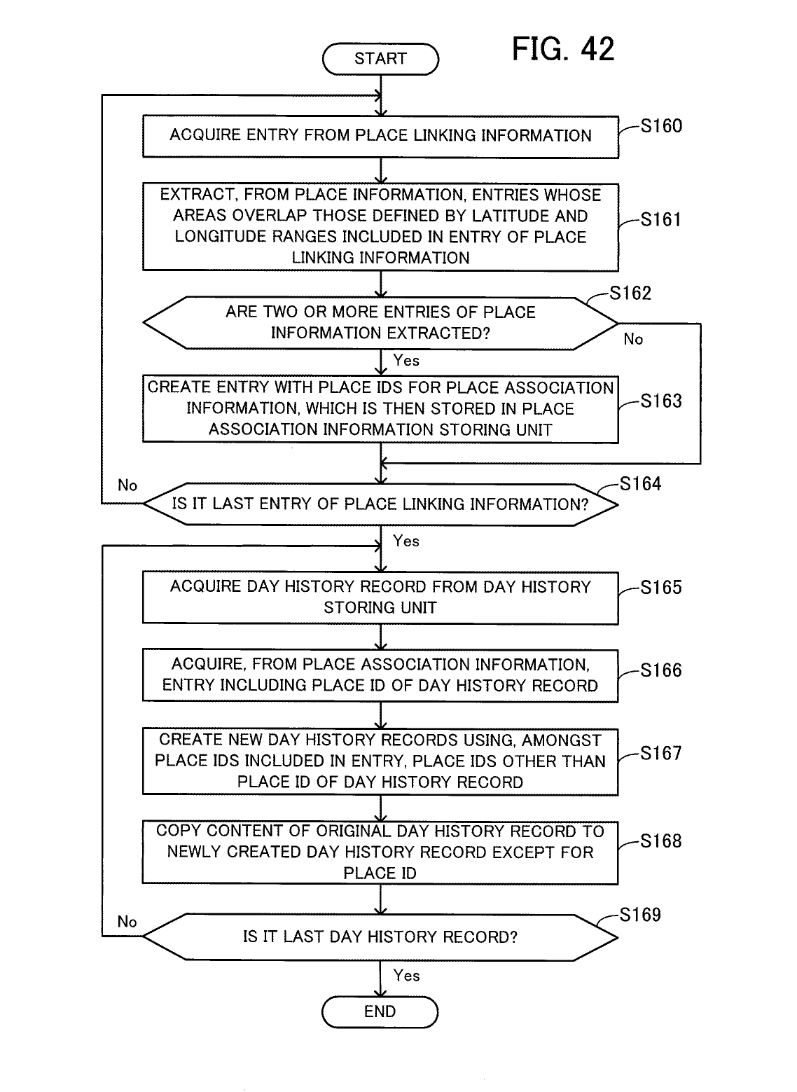

FIG. 42 is a flowchart illustrating an operation of the history converting unit for a day conversion process.

[Step S160] The history converting unit 23 acquires an entry of the place linking information from the place association information storing unit 29 (entries in the place linking information are acquired one at a time).

[Step S161] The history converting unit 23 extracts, from the place information, entries whose areas defined by their latitude and longitude ranges overlap areas defined by the latitude and longitude ranges included in the acquired entry of the place linking information. In this regard, the expanded areas are used as the areas defined by latitude and longitude ranges included in each entry of the place information.

In the case where the areas defined by the latitude and longitude ranges included in the entry of the place linking information overlap areas defined by a plurality of entries of the place information, the history converting unit 23 extracts all the entries of the place information. Therefore, the number of attributes of the place linking information is not always the same as that of the place association information.

[Step S162] The history converting unit 23 determines whether two or more entries have been extracted from the place information as a result of step S161. If two or more place information entries have been acquired, the process proceeds to step S163. If not, the process proceeds to step S164.

[Step S163] The history converting unit 23 creates an entry for place association information, having place identifiers included in the place information entries as its attributes, and stores the entry in the place association information stored in the place association information storing unit 29. Note here that the place identifiers stored as the entry of the place association information are ones eventually obtained after following one or more integrated place identifiers in the above-described manner.

[Step S164] The history converting unit 23 determines whether the entry currently targeted is the last entry of the place linking information. If the entry is the last one, the process proceeds to step S165. If not, the process returns to step S160.

[Step S165] The history converting unit 23 performs a process of adding one or more places associated with the place identifier included in each day history record. The following process is performed on all day history records stored in the day history record storing unit 22e. The history converting unit 23 acquires a day history record from the day history record storing unit 22e.

[Step S166] The history converting unit 23 acquires, from the place association information stored in the place association information storing unit 29, an entry including the place identifier of the acquired day history record.

[Step S167] The history converting unit 23 creates one or more new day history records using, amongst place identifiers included in the entry acquired in step S166, one or more place identifiers other than the place identifier included in the day history record. If the entry has three attributes of place identifiers, two day history records are newly created.

[Step S168] The history converting unit 23 copies the content of the original day history record to each of the newly created day history records except for the place identifier. Note that if a day history record with the place identifier included in each of the newly created day history records already exists, the newly created day history record is not added to the day history record storing unit 22e.

[Step S169] The history converting unit 23 determines whether the day history record currently targeted is the last day history record being the subject of the process. If the day history record is the last one, the process ends. If not, the process returns to step S165. Note that the place linking information may be manually set by the user, or automatically set using a Web service of converting latitude and longitude coordinates to geographical names or the like based on entries in the place information.

According to the fourth embodiment described above, places are associated with each other in such a manner that the places become predictable as relevant visiting places regardless of days of the week when visits were made in the past, which allows files likely to be used to be copied to the terminal 10 in advance.

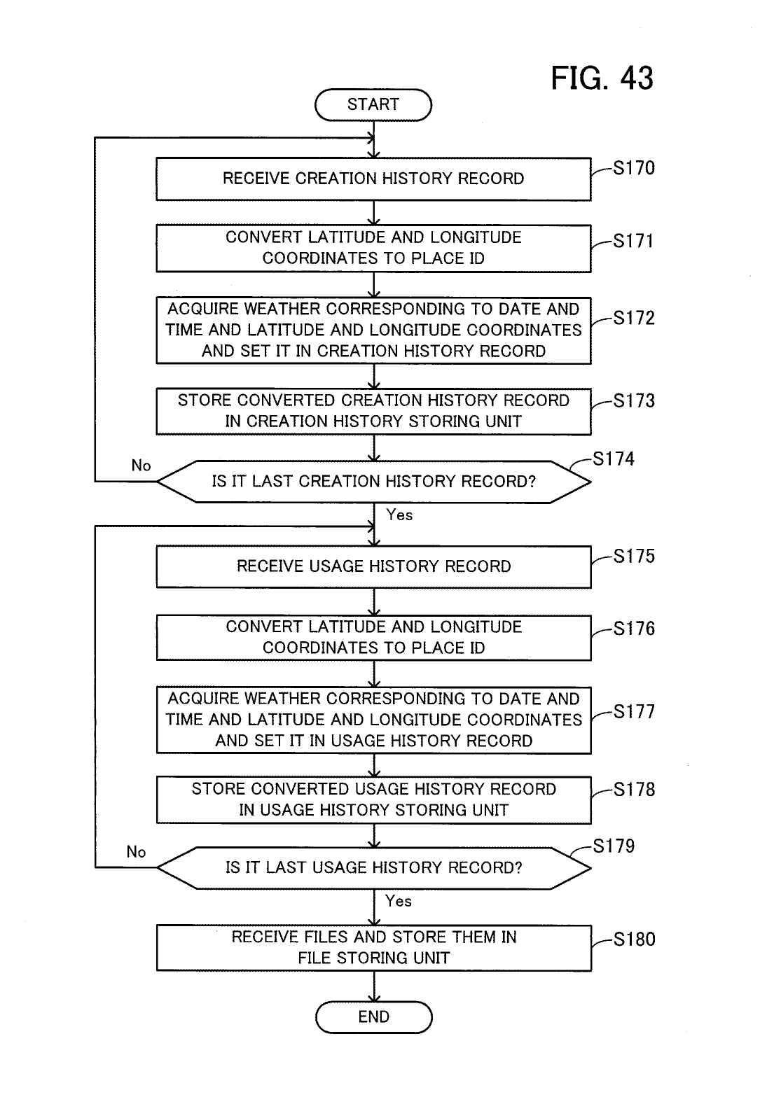

Next described is a modification in which file selection is based also on weather history records. FIG. 43 is a flowchart illustrating an operation of the file history archive unit.

[Step S170] The file history archive unit 21 receives a creation history record.

[Step S171] The file history archive unit 21 converts the latitude and longitude coordinates of the creation history record to a place identifier.

[Step S172] The file history archive unit 21 acquires the weather corresponding to the date and time and the latitude and longitude coordinates included in the creation history record and sets it in the creation history record.

[Step S173] The file history archive unit 21 stores the converted creation history record in the creation history storing unit 22b.

[Step S174] The file history archive unit 21 determines whether the creation history record currently targeted is the last creation history record being the subject of the process. If the creation history record is the last one, the process proceeds to step S175. If not, the process returns to step S170.

[Step S175] The file history archive unit 21 receives a usage history record.

[Step S176] The file history archive unit 21 converts the latitude and longitude coordinates of the usage history record to a place identifier.

[Step S177] The file history archive unit 21 acquires the weather corresponding to the date and time and the latitude and longitude coordinates included in the usage history record and sets it in the usage history record.

[Step S178] The file history archive unit 21 stores the converted usage history record in the usage history storing unit 22c.

[Step S179] The file history archive unit 21 determines whether the usage history record currently targeted is the last usage history record being the subject of the process. If the usage history record is the last one, the process proceeds to step S180. If not, the process returns to step S175.

[Step S180] The file history archive unit 21 receives corresponding files and stores them in the file storing unit 22a.

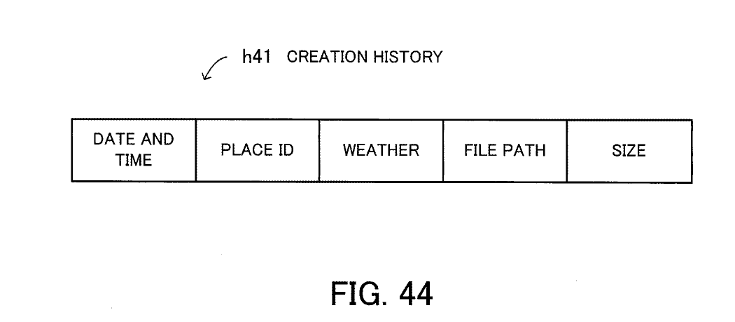

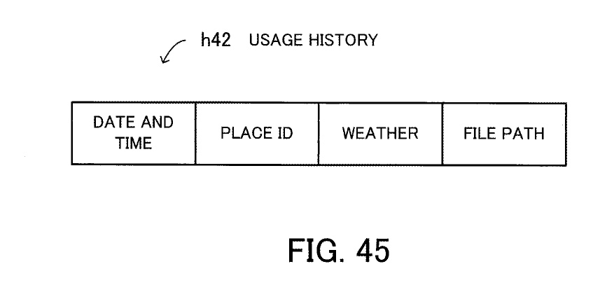

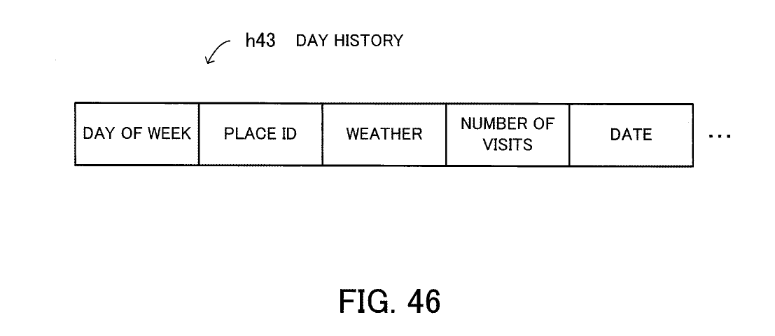

FIG. 44 illustrates an example of the data structure of a creation history, and FIG. 45 illustrates an example of the data structure of a usage history. A creation history h41 includes the following attributes: date and time; place identifier; weather; file path; and size. A usage history h42 includes the following attributes: date and time; place identifier; weather; and file path. FIG. 46 illustrates an example of the data structure of a day history. A day history h43 includes the following attributes: day of the week; place identifier; weather; number of visits; and date.

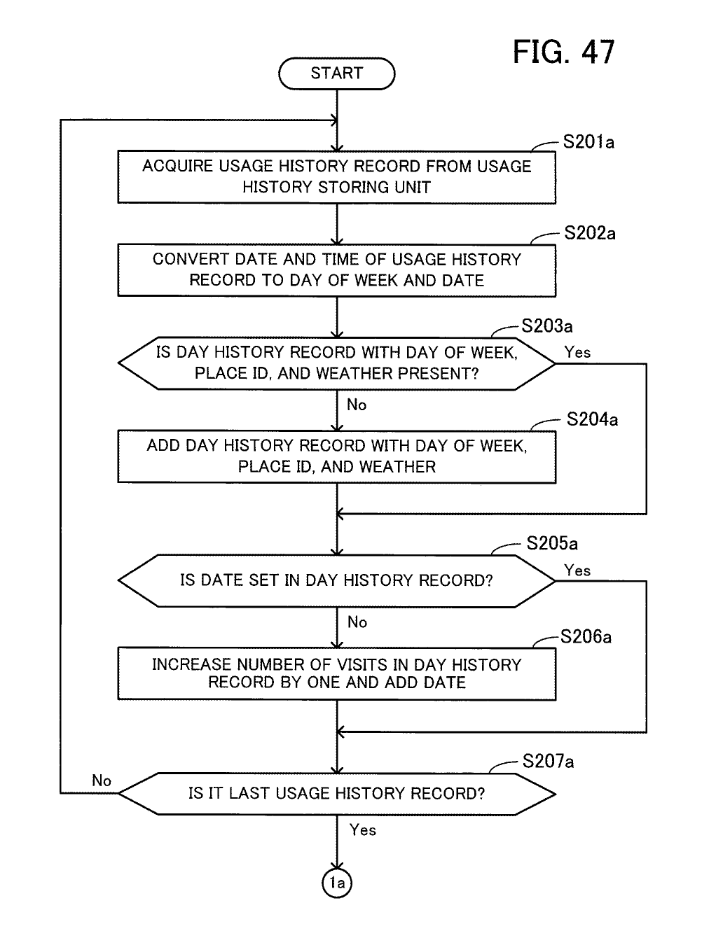

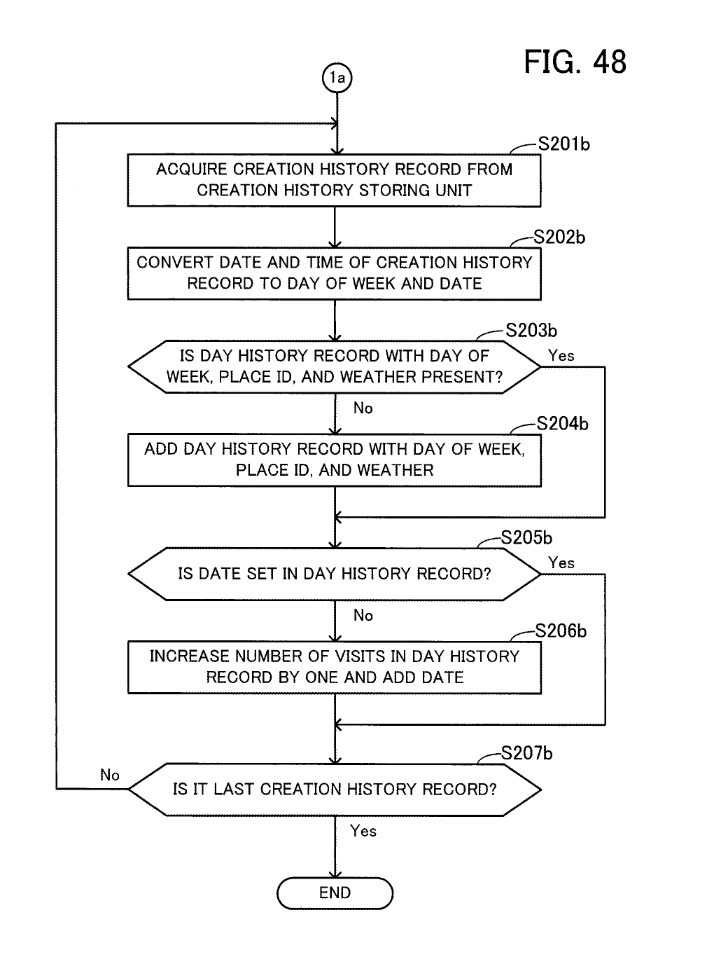

FIGS. 47 and 48 are flowcharts illustrating an operation of the history converting unit for day history conversion.

[Step S201a] The history converting unit 23 acquires a usage history record from the usage history storing unit 22c.

[Step S202a] The history converting unit 23 converts the date and time of the usage history record to a day of the week and a date.

[Step S203a] The history converting unit 23 determines whether a day history record with the day of the week converted in step S202a and the place identifier and weather included in the usage history record is present in the day history record storing unit 22e. If it is absent, the operation proceeds to step S204a. If it is present, the operation proceeds to step S205a.

[Step S204a] When the day history record is absent, the history converting unit 23 creates a day history record by newly setting the day of the week, the place identifier, and the weather.

[Step S205a] The history converting unit 23 determines whether the date converted in step S202a is set in the day history record. If the date is not set in the day history record, the operation proceeds to step S206a. If the date is set, the operation proceeds to step S207a.

[Step S206a] The history converting unit 23 increases the number of visits in the day history record by one, and adds the date converted from the date and time included in the usage history record to a field of the date in the day history record.

[Step S207a] The history converting unit 23 determines whether all usage history records have undergone the above process. If the usage history record is the last one, the operation proceeds to step S201b. If not, the operation returns to step S201a.

[Step S201b] The history converting unit 23 acquires a creation history record from the creation history storing unit 22b.

[Step S202b] The history converting unit 23 converts the date and time of the creation history record to a day of the week and a date.

[Step S203b] The history converting unit 23 determines whether a day history record with the day of the week converted in step S202b and the place identifier and weather included in the creation history record is present in the day history record storing unit 22e. If it is absent, the operation proceeds to step S204b. If it is present, the operation proceeds to step S205b.

[Step S204b] When the day history record is absent, the history converting unit 23 creates a day history record by newly setting the day of the week, the place identifier, and the weather.

[Step S205b] The history converting unit 23 determines whether the date converted in step S202b is set in the day history record. If the date is not set in the day history record, the operation proceeds to step S206b. If the date is set, the operation proceeds to step S207b.

[Step S206b] The history converting unit 23 increases the number of visits in the day history record by one, and adds the date converted from the date and time included in the creation history record to a field of the date in the day history record.

[Step S207b] The history converting unit 23 determines whether all creation history records have undergone the above process. If the creation history record is the last one, the operation ends. If not, the operation returns to step S201b.

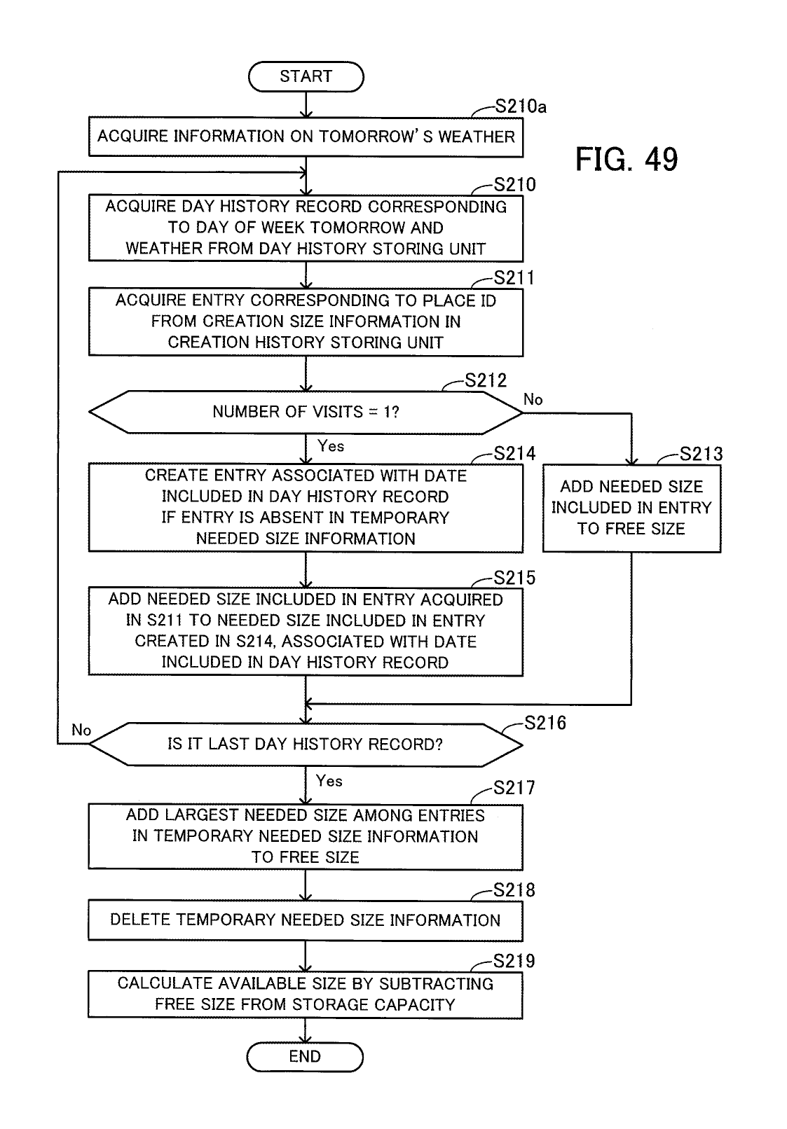

FIG. 49 is a flowchart illustrating an operation of the file determining unit.

[Step S210a] The file determining unit 24 acquires information on tomorrow's weather.

[Step S210] The file determining unit 24 acquires, from the day history storing unit 22e, a day history record corresponding to the day of the week tomorrow and the weather.

[Step S211] The file determining unit 24 acquires, from the creation size information in the creation history storing unit 22b, an entry corresponding to a place identifier included in the acquired day history record.

[Step S212] The file determining unit 24 determines whether the number of visits included in the day history record is one. If the number of visits is two or more, the operation proceeds to step S213. If the number of visits is one, the operation proceeds to step S214.

[Step S213] The file determining unit 24 adds the needed size included in the entry acquired in step S211 to the free size.

[Step S214] The file determining unit 24 acquires, from the temporary needed size information, an entry associated with the date included in the day history record. If such an entry is absent, the file determining unit 24 creates the entry.

[Step S215] The file determining unit 24 adds the needed size included in the entry acquired in step S211 to the needed size included in the entry acquired or created in step S214, associated with the date included in the day history record.

[Step S216] The file determining unit 24 determines whether the day history record currently targeted is the last one being the subject of the process. If the day history record is the last one, the operation proceeds to step S217. If not, the operation returns to step S210.

[Step S217] The file determining unit 24 selects, amongst created entries in the temporary needed size information, one with the largest needed size, and then adds the selected needed size to the free size.

[Step S218] The file determining unit 24 deletes the temporary needed size information. What is calculated in the above process is the free space to be secured in the terminal 10.

[Step S219] The file determining unit 24 subtracts the free size from the storage capacity of the terminal 10 to thereby obtain the available size.

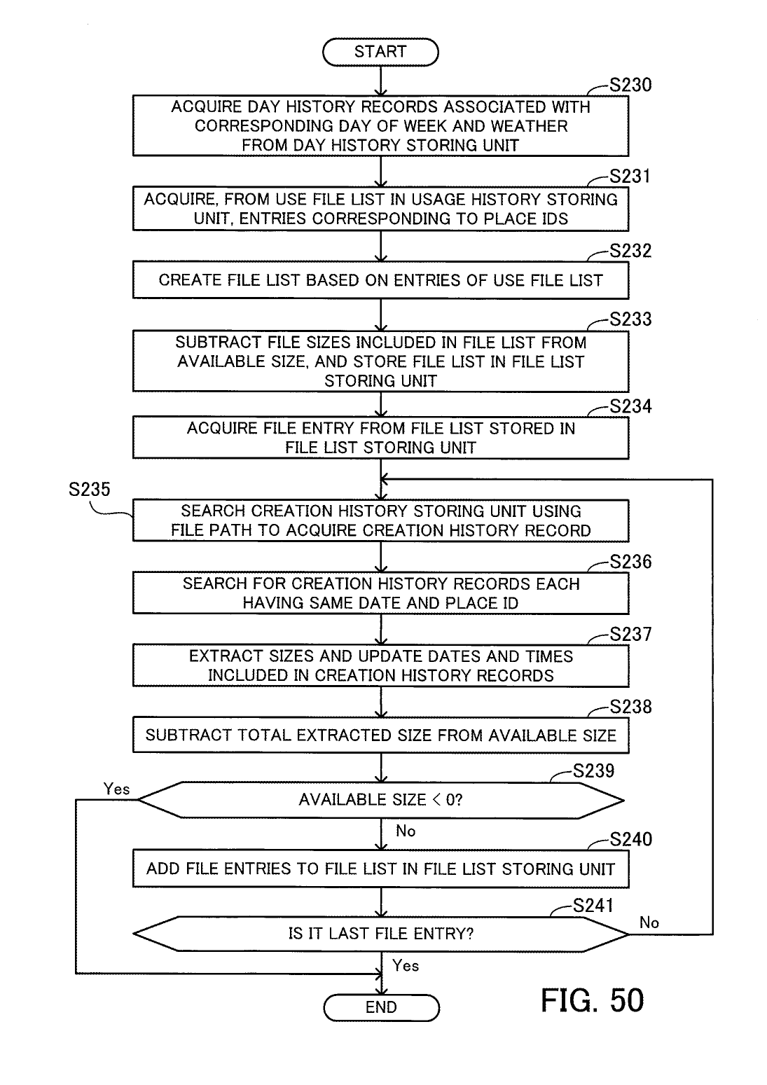

FIG. 50 is a flowchart illustrating an operation of the file determining unit for selecting files.

[Step S230] The file determining unit 24 acquires day history records associated with corresponding day of the week and weather from the day history storing unit 22e.

[Step S231] The file determining unit 24 acquires, from the use file list in the usage history storing unit 22c, entries each corresponding to one of place identifiers included in the acquired day history records.

[Step S232] The file determining unit 24 searches the file storing unit 22a using file paths included in each of the entries acquired from the use file list, and extracts, from the file storing unit 22a, the dates and times and sizes of files having the file paths. Then, the file determining unit 24 uses the extracted dates and times and sizes and the file paths to create a file list as illustrated in FIG. 9.

[Step S233] The file determining unit 24 determines whether the sizes included in the created file list exceed the available size calculated in step S219 of FIG. 49. In the case where the sizes of the file list exceed the available size, not all files in the file list are allowed to be copied to the terminal 10.

Therefore, the file determining unit 24 deletes some files from the file list so that the sizes included in the file list do not exceed the available size, and then stores the file list in the file list storing unit 26 after the deletion.

[Step S234] The file determining unit 24 acquires a file entry from the file list stored in the file list storing unit 26.

[Step S235] The file determining unit 24 acquires, from the creation history storing unit 22b, a creation history record with the same file path as that included in the acquired file entry.

[Step S236] The file determining unit 24 acquires, from the creation history storing unit 22b, one or more creation history records each having the same date and place identifier as those included in the creation history record acquired in step S235. Alternatively, the file determining unit 24 may acquire one or more creation history records each having the same place identifier only, regardless of its date.

[Step S237] The file determining unit 24 extracts the size and update date and time included in each of the acquired creation history records.

[Step S238] The file determining unit 24 subtracts the total file size extracted in step S237 from the available size.

[Step S239] The file determining unit 24 determines whether the available size is smaller than zero after the subtraction. If the available size is smaller than zero, the process ends because no more files are allowed to be stored in the terminal 10. On the other hand, if the available size is not smaller than zero, the process proceeds to step S240.

[Step S240] The file determining unit 24 additionally stores file entries corresponding to the creation history records acquired in step S236 in the file list storing unit 26 together with their file sizes and update dates and times.

[Step S241] The file determining unit 24 determines whether the file entry currently targeted is the last file entry being the subject of the process. If the file entry is the last one, the process ends. If not, the process returns to step S235.

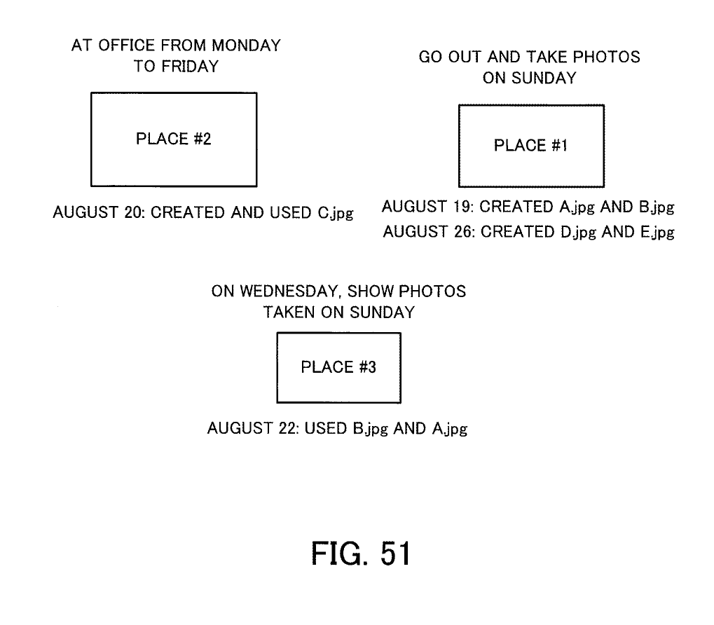

Next described are the history information and history conversion, using a specific example. FIG. 51 illustrates a pattern of activity of the user. Assume that the user is at the office (Place #2) from Monday to Friday, and he or she created and used a file of C.jpg on August 20. In addition, assume that the user visits Place #1 on Sunday, and he or she created files of A.jpg and B.jpg on August 19 and files of D.jpg and E.jpg on August 26. Further, assume that the user shows photos taken on Sunday at Place #3 on Wednesday, and he or she used the files B.jpg and A.jpg on August 22.

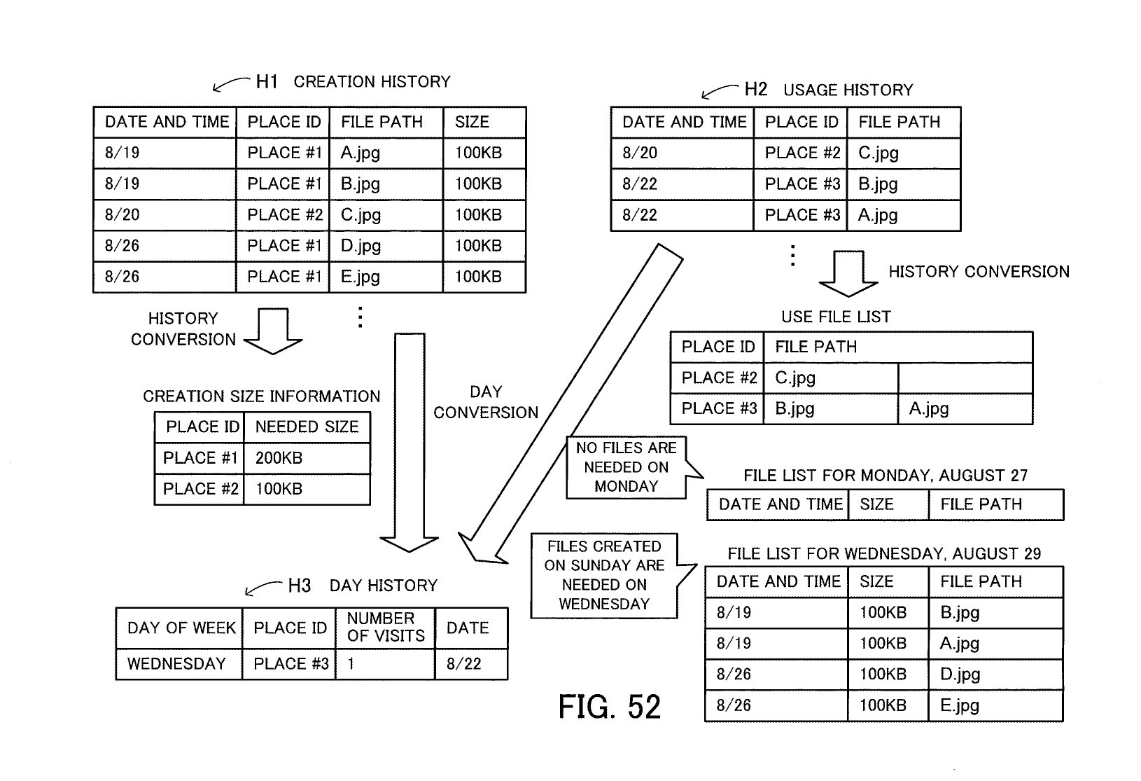

FIG. 52 illustrates history information and history conversion. File creation history records obtained by the pattern of activity of FIG. 51 are registered in a creation history H1 (assume that all files have a size of 100 KB). In addition, file usage history records obtained by the pattern of activity of FIG. 51 are registered in a usage history H2. On the other hand, creation size information is generated by converting the creation history H1, and the needed sizes for Place #1 and #2 are calculated to be 200 KB and 100 KB, respectively. In addition, a use file list is generated by converting the usage history H2, and indicates that Place #2 is associated with the file path C.jpg and Place #3 is associated with the file paths B.jpg and A.jpg. Further, a day history H3 is generated based on the creation history H1 and the usage history H2. The day history H3 indicates that the user visited Place #3 once on Wednesday, August 22.

In this setting, no files are predicted to be used on Monday, August 27, and therefore no entries are made in the file list for Monday, August 27. On the other hand, files created at Place #3 on Sunday are predicted to be used on Wednesday, August 29, and therefore entries of the 100 KB files, B.jpg and A.jpg, created on August 19 and entries of the 100 KB files, D.jpg and E.jpg, created on August 26 are registered in the file list for Wednesday, August 29.

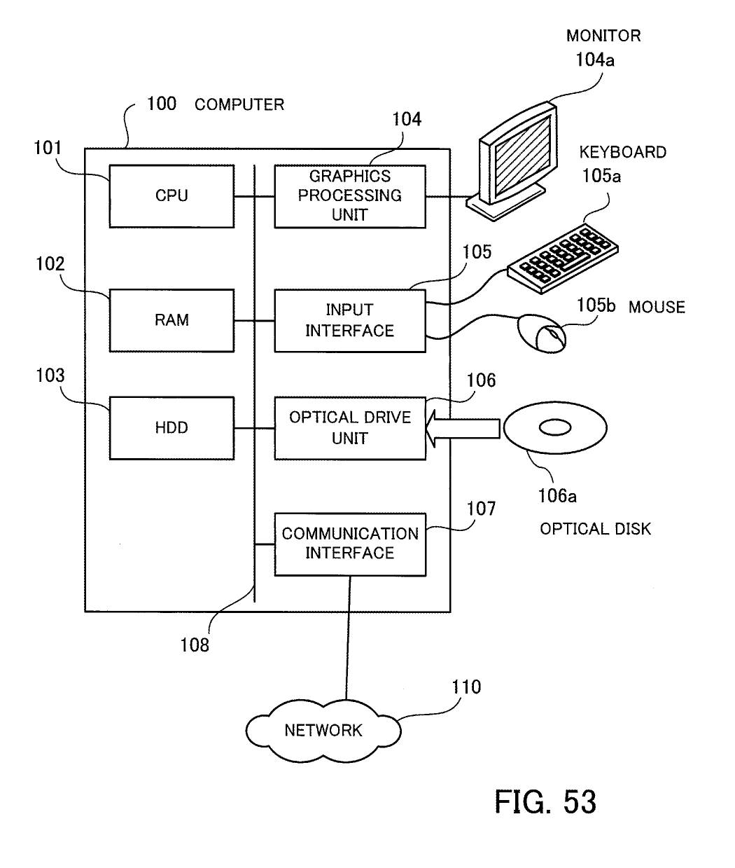

Note that the above-described processing functions may be implemented by a computer. FIG. 53 illustrates an example of a hardware configuration of a computer used for the information processors according to the embodiments above. Overall control of a computer 100 is exercised by a central processing unit (CPU) 101. To the CPU 101, random access memory (RAM) 102 and a plurality of peripherals are connected via a bus 108. The RAM 102 is used as a main storage device of the computer 100. The RAM 102 temporarily stores at least part of an operating system (OS) program and application programs to be executed by the CPU 101. The RAM 102 also stores therein various types of data to be used by the CPU 101 for its processing.

The peripherals connected to the bus 108 include a hard disk drive (HDD) 103, a graphics processing unit 104, an input interface 105, an optical drive unit 106, and a communication interface 107. The HDD 103 magnetically writes and reads data to and from a built-in disk, and is used as a secondary storage device of the computer 100. The HDD 103 stores therein the OS program, application programs, and various types of data. Note that a semiconductor storage device such as a flash memory may be used as a secondary storage device in place of the HDD 103.

To the graphics processing unit 104, a monitor 104a is connected. According to an instruction from the CPU 101, the graphics processing unit 104 displays an image on a screen of the monitor 104a. A cathode ray tube (CRT) display or a liquid crystal display may be used as the monitor 104a. To the input interface 105, a keyboard 105a and a mouse 105b are connected. The input interface 105 transmits signals sent from the keyboard 105a and the mouse 105b to the CPU 101. Note that the mouse 105b is just an example of pointing devices, and a different pointing device such as a touch panel, a tablet, a touch-pad, and a track ball, may be used instead.

The optical drive unit 106 reads data recorded on an optical disk 106a using, for example, laser light. The optical disk 106a is a portable storage medium on which data is recorded to be read by reflection of light. Examples of the optical disk 106a include a digital versatile disc (DVD), a DVD-RAM, a compact disk read only memory (CD-ROM), a CD recordable (CD-R), and a CD-rewritable (CD-RW). The communication interface 107 is connected to a network 110. Via the network 110, the communication interface 107 transmits and receives data to and from different computers and communication devices.

The hardware configuration described above achieves the processing functions of each information processor of the above-described embodiments. In the case of achieving the processing functions of each embodiment by a computer, a program is provided which describes processing contents of the functions to be implemented by the information processors above. By executing the program on the computer, the above-described processing functions are achieved on the computer. The program in which the processing contents are described may be recorded on computer-readable storage media. Such computer-readable storage media include a magnetic storage device, an optical disk, a magneto-optical storage medium, and a semiconductor memory. Examples of the magnetic storage device are a HDD, a flexible disk (FD), and a magnetic tape. Examples of the optical disk are a DVD, a DVD-RAM, a CD-ROM, and a CD-RW. An example of the magneto-optical storage medium is a magneto-optical disk (MO). Note that transitory propagating signals per se are not considered here as a computer-readable storage medium.

To distribute the program, for example, portable storage media, such as DVDs and CD-ROMs, on which the program is recorded are sold. In addition, the program may be stored in a memory device of a server computer and then transferred from the server computer to another computer via a network. A computer for executing the program stores, for example, in its own memory device, the program which is originally recorded on a portable storage medium or transferred from the server computer. Subsequently, the computer reads the program from its own memory device and performs processing according to the program. Note that the computer is also able to read the program directly from the portable storage medium and perform processing according to the program. In addition, the computer is also able to sequentially perform processing according to a received program each time such a program is transferred from a server computer.

In addition, at least part of the above-described processing functions may be achieved by an electronic circuit, such as a digital signal processor (DSP), an application specific integrated circuit (ASIC), and a programmable logic device (PLD). Note that the above describes an example of the hardware configuration of the information processors; however, the hardware configuration is also applicable to the terminal of the embodiments above. In this case, a sensor for acquiring positional information is added to the configuration.

As has been described above, according to the embodiments discussed herein, the way the user created and used files is stored in association with places. Then, the free space of the storage to be secured is calculated based on places the user is scheduled to visit on a particular day and histories of file creation and use associated with the places, and then data likely to be used while the user is visiting the places is copied to the storage. This allows accurate selection and copy of files likely to be used by the user. In addition, it is possible to configure the storage based on the activity of the user.

According to one aspect of the embodiments, files likely to be used at places a user is scheduled to visit are selected with accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A file selection system comprising:
a terminal configured to transmit files and usage history records each including information on a file use position at which a corresponding one of the files was used; and
an information processor configured to include a processor configured to perform a procedure including:
receiving the files and the usage history records transmitted from the terminal,
determining, based on each of the usage history records, a place with a spatial extent including the file use position,
managing each of the files in association with the corresponding place,
selecting files according to one or more places to which the terminal is scheduled to move, and
transmitting the selected files to the terminal.

2. The file selection system according to claim 1, wherein:
the terminal transmits creation history records each including information on a file creation position at which a corresponding one of the files was created; and
the procedure of the processor further includes:
receiving the files and the creation history records transmitted from the terminal,
determining, based on each of the creation history records, a place with a spatial extent including the file creation position,
calculating a file size of files created at each of the places, and
designating a total file size as free space to be secured to create files at the places to which the terminal is scheduled to move, the total file size being obtained by adding up the file sizes corresponding to the places to which the terminal is scheduled to move.

3. The file selection system according to claim 2, wherein:
the procedure of the processor further includes designating a value obtained by subtracting the free space from storage capacity of the terminal as an available size for storing copies of files on the terminal, and
the selecting includes selecting the files to be transmitted to the terminal without exceeding the available size.

4. The file selection system according to claim 3, wherein:
the managing includes creating a file list indicating files likely to be used at the places to which the terminal is scheduled to move; and
the selecting includes selecting the files to be transmitted to the terminal based on the file list.

5. The file selection system according to claim 4, wherein:
the managing includes adding, to the file list, files created at the same places as the files listed in the file list.

6. The file selection system according to claim 4, wherein:
the procedure of the processor further includes transmitting the file list to the terminal;
when receiving the file list, the terminal deletes attributes of files already held in the terminal from the file list, and then returns the file list to the information processor after the deletion; and
the transmitting the selected files includes transmitting files indicated by the returned file list to the terminal.

7. The file selection system according to claim 1, wherein:
the procedure of processor further includes:
determining, when the file use position indicated by the information received from the terminal is located within a place with a spatial extent set around a different position, that the file use position is included in the place,
generating, when there is no place with a spatial extent including the file use position, expanded areas by expanding spatial extents of existing places,
determining, when the file use position is located within one of the expanded areas, that the file use position is included in a place based on which the expanded area is generated, and
generating, when the file use position is located within two or more of the expanded areas, an integrated place integrating places based on which the two or more expanded areas are generated, and determining that the file use position is included in the integrated place.

8. The file selection system according to claim 2, wherein:
the procedure of the processor further includes generating, based on the creation history records transmitted from the terminal, day history records each including a day of a week on which one or more files were created, a place at which the files were created, a number of visits made to the place, and one or more dates of the files being created.

9. The file selection system according to claim 8, wherein:
the procedure of the processor further includes:
acquiring one or more of the day history records including the same day of the week,
calculating, based on the acquired day history records, a first total file size and one or more second total file sizes, the first total file size being obtained by adding up sizes of files created at one or more places each with the number of visits being more than one, and the second total file sizes being obtained by adding up, for each of the dates, sizes of files created at one or more places each with the number of visits being one,
selecting a largest one of the second total file sizes, and
designating, as the free space, a file size obtained by adding together the first total file size and the selected second total file size.

10. The file selection system according to claim 4, wherein:
the procedure of the processor further includes determining a degree of matching between each image included in the files transmitted from the terminal and each image included in external files created by an apparatus different from the terminal; and
the managing includes adding, to the file list, one or more of the external files with the degree of matching exceeding a predetermined threshold.

11. The file selection system according to claim 1, wherein:
the managing includes associating each of the files with one or more relevant places related to the corresponding place.

12. The file selection system according to claim 11, wherein:
the managing includes determining, when latitude and longitude ranges of each of the relevant places have an overlap with latitude and longitude ranges of the corresponding place or an expanded area generated by expanding the corresponding place, that the relevant place is related to the corresponding place.

13. An information processor comprising:
a processor configured to perform a procedure including:
receiving files and usage history records transmitted from a terminal, each of the usage history records including information on a file use position at which a corresponding one of the files was used,
determining, based on each of the usage history records, a place with a spatial extent including the file use position,
managing each of the files in association with the corresponding place,
selecting files according to one or more places to which the terminal is scheduled to move, and
transmitting the selected files to the terminal.

14. A terminal comprising:
a processor configured to perform a procedure including:
storing files, and
transmitting the files and usage history records each including information on a file use position at which a corresponding one of the files was used.
